(19) United States
(12) Patent Application Publication
(10) Pub. No.: US 2023/0196136 A1
(43) Pub. Date: Jun. 22, 2023

(54) MACHINE LEARNING MODEL PREDICTIONS VIA AUGMENTING TIME SERIES OBSERVATIONS

(71) Applicant: EQUIFAX INC., Atlanta, GA (US)

(72) Inventors: James CAMPOLONG, Gainesville, GA (US); Joji VARUGHESE, Alpharetta, GA (US); Stephen MILLER, Chesterfield, MO (US)

(21) Appl. No.: 18/069,594

(22) Filed: Dec. 21, 2022

Related U.S. Application Data
(60) Provisional application No. 63/292,566, filed on Dec. 22, 2021.

(51) Int. Cl. G06N 5/022

(52) U.S. Cl. CPC G06N 5/022

(57) ABSTRACT

A system receives, from a remote computing device, a query for a timing of an adverse event associated with a target entity. The system determines, using a timing prediction model trained using a training process, the timing of the adverse event for the target entity from predictor variables associated with the target entity. The training process includes accessing an observational journal comprising historical panel data of the target entity including values of predictor variables for one or more time points and generating, from historical panel data, an augmented time series by augmenting the historical panel data with values of predictor variables for at time points for which the historical panel data does not include values of predictor variables. The system transmits to the remote computing device, a responsive message including at least the timing of the adverse event for use in controlling access of the target entity to one or more interactive computing environments.

### CROSS-REFERENCE TO RELATED APPLICATION

This application claims priority to U.S. Provisional Application No. 63/292,566 filed Dec. 22, 2021 and entitled “Machine Learning Model Predictions Via Augmenting Time Series Observations Using A Derived Observational Journal,” the entire content of which is incorporated herein by reference.

### TECHNICAL FIELD

The present disclosure relates generally to artificial intelligence. More specifically, but not by way of limitation, this disclosure relates to systems that can use machine-learning modeling algorithms for predictions that can impact machine-implemented operating environments.

### BACKGROUND

In machine learning, machine-learning modeling algorithms can be used to perform one or more functions (e.g., acquiring, processing, analyzing, and understanding various inputs in order to produce an output that includes numerical or symbolic information). For instance, machine-learning techniques can involve using computer-implemented models and algorithms (e.g., a convolutional neural network, a support vector machine, etc.) to simulate human decision-making. In one example, a computer system programmed with a machine-learning model can learn from training data and thereby perform a future task that involves circumstances or inputs similar to the training data. Such a computing system can be used, for example, to recognize certain individuals or objects in an image, to simulate or predict future actions by an entity based on a pattern of interactions to a given individual, etc.

### SUMMARY

The present disclosure describes techniques for generating, by a model development system, augmented time series data. For example, a model development system receives, from a remote computing device, a query for a timing of an adverse event associated with a target entity. The model development system determines, using a timing prediction model trained using a training process, the timing of the adverse event for the target entity from predictor variables associated with the target entity. The training process includes accessing an observational journal comprising historical panel data of the target entity including values of predictor variables for one or more time points and generating, from historical panel data, an augmented time series by augmenting the historical panel data with values of predictor variables for at time points for which the historical panel data does not include values of predictor variables. The model development system transmits to the remote computing device, a responsive message including at least the timing of the adverse event for use in controlling access of the target entity to one or more interactive computing environments.

Various embodiments are described herein, including methods, systems, non-transitory computer-readable storage media storing programs, code, or instructions executable by one or more processors, and the like. These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 is a block diagram depicting an example of a computing system in which a development computing system trains a timing-prediction model that is used by one or more host computing systems, according to certain embodiments disclosed herein.

FIG. 1A is a flow chart depicting an example of a process for utilizing a timing prediction model to predict a time of an adverse event based on predictor variables, according to certain embodiments disclosed herein.

FIG. 2 depicts an example of a process 200 for training the timing-prediction model of FIG. 1 and thereby estimating a time period in which a target event will occur, according to certain embodiments disclosed herein.

FIG. 3 depicts an example of a process 300 for generating, from historical panel data, augmented time series data from which training data can be accessed for training the timing-prediction model of FIG. 1 using the process described in FIG. 2, according to certain embodiments disclosed herein.

FIG. 4A depicts an example illustration of a portion of historical panel data , in accordance with certain embodiments described herein.

FIG. 4B depicts an example illustration of the portion of historical panel data of FIG. 4A which is hierarchically sorted, in accordance with certain embodiments described herein.

FIG. 4C depicts an example illustration of the sorted portion of historical panel data of FIG. 4B in which duplicate observations are removed to generate a reduced sorted portion of historical panel data, in accordance with certain embodiments described herein.

FIG. 5 depicts an example illustration of augmented time series data at a daily interval for a customer and trade key, based on the reduced sorted portion of historical panel data of FIG. 4C, in accordance with certain embodiments described herein.

FIG. 6 is a block diagram depicting an example of a computing system that can be used to implement one or more of the systems depicted in FIG. 1, according to certain embodiments disclosed herein.

### DETAILED DESCRIPTION

Certain aspects described herein improve how computing systems represent time series data for input to machine-learning models. For example, the methods described herein for generating augmented time series data from a set of panel data. Using methods described herein to generate time series data for training computer-implemented models can allow for more effective prediction of the timing of certain adverse events, which in turn can facilitate the adaptation of an operating environment based on the adverse event timing. For example, adaptation of the operating environment can include granting or denying access to users. Thus, certain aspects can effect improvements to machine-implemented operating environments that are adaptable based on the predicted timing of adverse events with respect to those operating environments. Also, certain aspects described herein improve how computing systems explain outputs of machine-learning models. For instance, the approaches described herein can generate augmented time series data at multiple predefined frequencies (e.g. daily, weekly, biweekly), and determine an effect of frequency on adverse event timing predictions. Employment of such approaches can allow for a clearer or more accurate explanation of model predictions over conventional approaches.

Certain aspects and features of the present disclosure involve training and applying modeling algorithms to predictor variable data and thereby estimating a time period in which a target event (e.g., an adverse action) of interest will occur. In some aspects, such modeling algorithms use, as input, a set of predictor variable data generated from time series data (e.g., panel data). Modeling algorithms include, for example, binary prediction algorithms that involve models such as neural networks, support vector machines, logistic regression, etc. Each modeling algorithm can be trained to predict, for example, an adverse action based on data from a particular time period. An automated modeling system can use modeling algorithms to perform a variety of functions including, for example, utilizing various independent variables and computing an estimated time period in which a predicted response, such as an adverse action or other target event, will occur. This timing information can be used to modify a machine-implemented operating environment to account for the occurrence of the target event.

In some aspects, a model-development environment can train a modeling algorithm. The model-development environment can generate a machine-learning model from a set of time series training data for a particular training window, such as a 60-month period for which training data is available. In some aspects, the model-development environment can generate augmented time series data to increase a frequency (e.g. decrease a time interval) of historical panel data and retrieve training data for a training window from the augmented time series data. For example, the model-development environment can access an archive of time series data received and recorded at a first frequency (e.g. monthly) and can generate augmented time series data having a second frequency of observations (e.g. weekly or daily) that is greater than the first frequency, by augmenting the time series data to account for missing observation time intervals (e.g. missing observation dates). Accordingly, an observation frequency interval in the augmented time series can be less than an observation frequency interval in the original historical panel data. For instance, the model-development environment can receive, periodically, historical panel data for one or more entities that includes data describing, for each entity, variable values for accounts of the given entity for one or more dates within the last (e.g. monthly) interval. The model development environment can generate augmented time series data describing attributes for accounts of the given entity over shorter (e.g. daily) intervals than the interval of the received data within the training window by augmenting the time series data to account for any missing observations. Once the augmented time series data for the training window is generated, the model-development environment may append the augmented time series data as the model-development environment receives, using an observational journal, additional time series data.

Continuing with this example, in some instances, the model-development environment can access historical panel data for one or more entities and generate an augmented time series by augmenting the historical panel data to generate augmented time series data. Augmenting the historical panel data can include replicating, in the historical panel data, existing observations so as to increase a frequency of observations over one or more time periods of the historical panel data. By generating the augmented time series data, a granularity of a time series data can be increased. In certain examples, the model-development entity can group archives of time series data for one or more entities within the augmented time series data according to observation type and generate separate augmented time series data associated with each observation type (e.g., a trade, a collection, an inquiry, etc.). For example, the transaction date of each respective observation in the time series data corresponds to a date at which the model-development system (or other system that manages the archive data) received and/or recorded the respective observation in the archive. The model-development environment can remove repeat/duplicate observations for a particular segment within the historical panel data For example, repeat observations may be one or more successive observations (according to transaction date) to a previous observation in which an observation value does not change in view of the previous observation. In this example, the model-development environment may remove, for a set including an observation and one or more repeat observations, the observations and all repeat observations in the set except for the earliest repeat observation having an earliest transaction date. In some instances, the model-development environment can organize observation data for the segment within the historical panel data according to a valid date. For example, the valid date for each observation within the historical panel data corresponds to a date at which the respective observation occurred (e.g. an actual transaction date). In some instances, the valid date does not correspond to the transaction date. As previously discussed, the transaction date is the date at which the system (e.g. a creditor, a financial institution, etc.) that reports the observation to the model development environment logs the observation. For example, for an example observation, the actual date of a transaction (e.g. valid date) is Mar. 2, 2020 but the date at which the observation is logged by the system that reports the observation is Mar. 5, 2020. In this example, the model development environment may receive a set of observations including this observation (including valid date and transaction date information) in an archive of panel data on Mar. 31, 2020. In some instances, the valid date can correspond to the transaction date. For example, the valid date and transaction date for an observation could be Apr. 15, 2020. In this example, the system that reports the observation logs the observation on Apr. 15, 2020 and the transaction or other activity associated with the observation actually takes place on Apr. 15, 2020.

Continuing with this example, in some instances, the model-development environment can generate missing observation data for the augmented time series data by replicating (e.g. carrying forward) observations so that the augmented time series includes observation data for a set of valid dates of a predefined frequency (e.g. daily observations). For example, the predefined frequency for the augmented time series data is a daily frequency and the augmented time series includes a set of observations organized according to valid date. In this example, however, the historical panel data is missing, for an account associated with an entity, observations for one or more dates between valid dates. For example, the historical panel data, for the month of April 2020, can include observations of an attribute value for an entity and a particular account corresponding to valid dates for April 1 (account balance: $500) and April 7 (account balance: $450). In this example, the model-development environment can replicatethe observation value of balance: $500 corresponding to valid date April 1 for each of the valid dates of April 2, 3, 4, 5, and 6, which are missing observation values. Likewise, in this example, the model-development environment can replicate the observation of balance: $450 corresponding to April 7 to apply to each of valid dates of April 8-30, 2020 in the historical panel data which are missing observation data. Accordingly, the generated augmented time series data can create a record of attributes or features with shorter intervals (greater frequency) than the intervals at which historical panel data are generally included in periodically-received panel data reports.

In some embodiments, the model-development environment can generate wavelet variable predictor data for the training window from time series data for the given entity selected from the augmented time series data. In the training process, the model-development environment can train a machine-learning model to compute a probability of an adverse action occurring if a certain set of predictor data values (e.g., user attribute values, wavelet predictor variable values) are encountered. In certain embodiments, the model-development environment can apply one or more trained models to compute an estimated timing of an adverse action. In certain embodiments, the model-development environment determines a wavelet transform to represent the selected time series data in the augmented time series data and determines wavelet predictor variable data using a wavelet transform and the time series data. A set of time series data from the observational augmented time series data can be represented as a weighted set of scaled and shifted basis functions. The set of coefficients (i.e., the weights) can be a wavelet transform (e.g. Haar wavelet transform or other type of wavelet transform) of that time series data. The set of coefficients may be the input data (i.e., the wavelet predictor variable data) for a modeling process described herein. For instance, the wavelet predictor variable data can include, for each scale of the wavelet, a set of coefficient values corresponding to each shift. The model-development environment can compute an adverse action probability for each scale of the wavelet predictor variable data. For instance, the model-development environment computes an adverse action probability for a scale by applying the first machine-learning model to predictor variable values that include a corresponding set of shift values for the scale. For instance, the adverse action probability, which is generated from the training data from the training window, can indicate a probability of an adverse action occurring within a target window.

Certain aspects can include operations and data structures with respect to prediction models or other models that improve how computing systems service represent time series data for input to machine-learning models. For instance, a particular set of rules are employed in the generation of time series data from the historical panel data that are implemented via program code. This particular set of rules allow, for example, a model to be trained using augmented time series data of a predefined frequency (e.g., daily) that is seeded from time series archive data of a frequency (e.g., monthly) that is lower than the predefined frequency and augmented to include any missing observation values. Employment of methods described herein to augment missing observations to the historical panel data for use in the training of these computer-implemented models can allow for more effective prediction of the timing of certain events, which can in turn facilitate the adaptation of an operating environment based on that timing prediction (e.g., modifying an industrial environment based on predictions of hardware failures, modifying an interactive computing environment based on risk assessments derived from the predicted timing of adverse events, etc.). Also, employment of methods described herein to generate an augmented time series at an observation frequency (e.g., daily) that is greater than what is available in conventional historical panel data (e.g., monthly or biweekly) for use in the training of these computer-implemented models can improve an accuracy of prediction of the timing of adverse events as well as enable predictions at more precise intervals (e.g., a target day within a month as opposed to a mid-month date or end-of-month date), because the models are trained on a finer granularity of training data. The increased accuracy of prediction of the trained model employing the methods described herein results in more useful control of the operating environment. For example, the methods described herein could, compared to a conventionally-trained model, predict an earlier date for an adverse event and, therefore, provide an earlier modification of the interactive computing environment. Thus, certain aspects can affect improvements to machine-implemented operating environments that are adaptable based on the timing of target events with respect to those operating environments.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative examples but, like the illustrative examples, should not be used to limit the present disclosure.

### Example of a Computing Environment for Implementing Certain Aspects

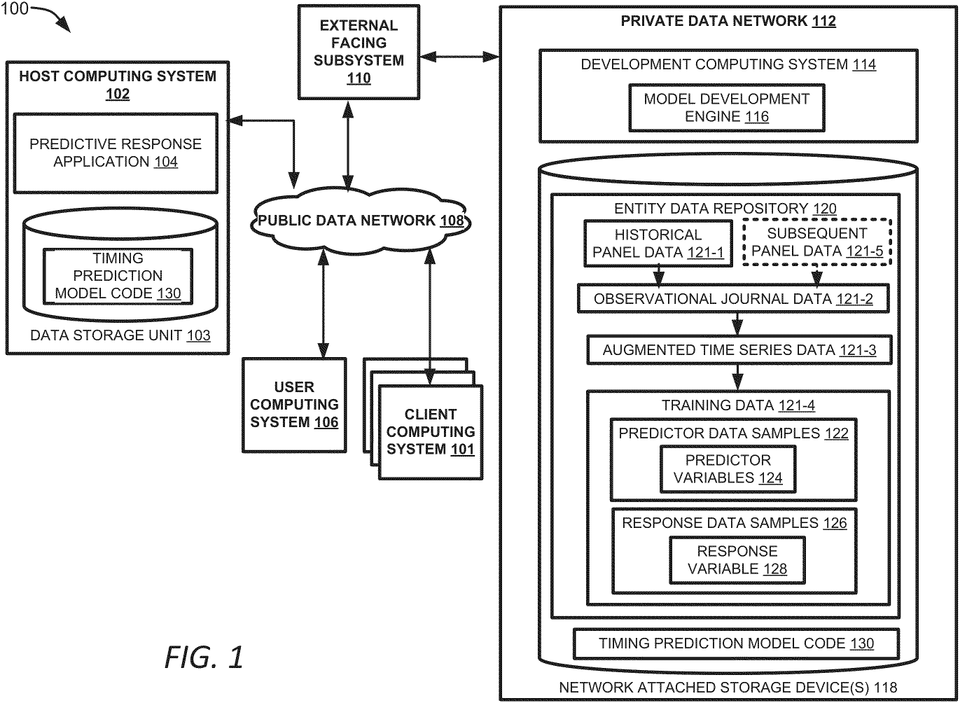

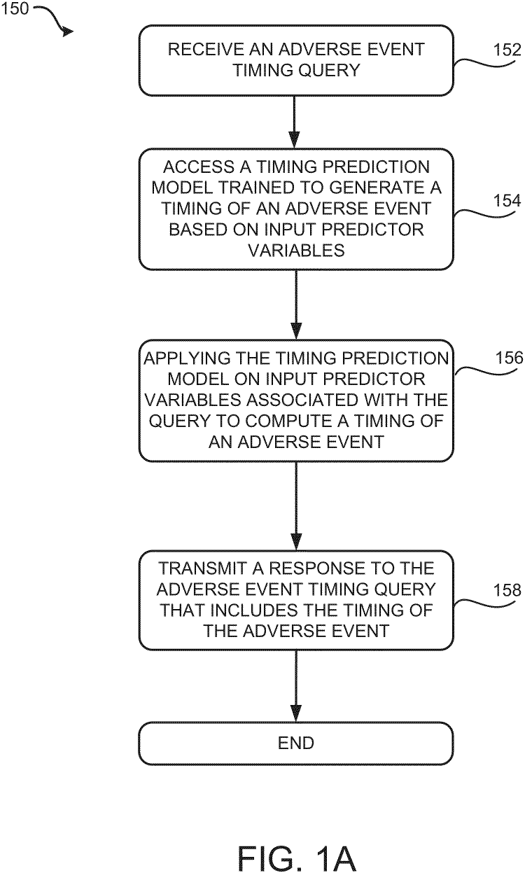

Referring now to the drawings, FIG. 1 is a block diagram depicting an example of a operating environment 100 in which a development computing system 114 trains one or more timing prediction models that are used by one or more host computing systems. FIG. 1 depicts examples of hardware components of a operating environment 100, according to some aspects. The numbers of devices depicted in FIG. 1 are provided for illustrative purposes. Different numbers of devices may be used. For example, while various elements are depicted as single devices in FIG. 1, multiple devices may instead be used.

The operating environment 100 can include a host computing system 102. A host computing system 102 can communicate with one or more of a user computing system 106, a development computing system 114, etc. For example, a host computing system 102 can send data to a target system (e.g., the user computing system 106, the development computing system 114 etc.) to be processed. The host computing system 102 may send signals to the target system to control different aspects of the computing environment or the data it is processing, or some combination thereof. A host computing system 102 can interact with the development computing system 114, the user computing system 106, or both via one or more data networks, such as a public data network 108.

A host computing system 102 can include any suitable computing device or group of devices, such as (but not limited to) a server or a set of servers that collectively operate as a server system. Examples of host computing systems 102 include a mainframe computer, a grid computing system, or other computing system that executes an automated modeling algorithm, which uses a timing prediction model with learned relationships between independent variables and the response variable. For instance, a host computing system 102 may be a host server system that includes one or more servers that execute a predictive response application 104 and one or more additional servers that control an operating environment. Examples of an operating environment include (but are not limited to) a website or other interactive computing environment, an industrial or manufacturing environment, a set of medical equipment, a power-delivery network, etc. In some aspects, one or more host computing systems 102 may include network computers, sensors, databases, or other devices that may transmit or otherwise provide data to the development computing system 114. For example, the host computing system 102 may include local area network devices, such as routers, hubs, switches, or other computer networking devices.

In some aspects, the host computing system 102 can execute a predictive response application 104, which can include or otherwise utilize timing-prediction model code 130 that has been optimized, trained, or otherwise developed using the model-development engine 116, as described in further detail herein. In additional or alternative aspects, the host computing system 102 can execute one or more other applications that generate a predicted response, which describes or otherwise indicate a predicted behavior associated with an entity. Examples of an entity include a system, an individual interacting with one or more systems, a business, a device, etc. These predicted response outputs can be computed by executing the timing-prediction model code 130 that has been generated or updated with the model-development engine 116.

The operating environment 100 can also include a development computing system 114. The development computing system 114 may include one or more other devices or subsystems. For example, the development computing system 114 may include one or more computing devices (e.g., a server or a set of servers), a database system for accessing the network-attached storage devices 118, a communications grid, or both. A communications grid may be a grid-based computing system for processing large amounts of data.

The development computing system 114 can include one or more processing devices that execute program code stored on anon-transitory computer-readable medium. The program code can include a model-development engine 116. Timing-prediction model code 130 can be generated or updated by the model-development engine 116 using the predictor data samples 122 and the response data samples 126. For instance, the model-development engine 116 can use the predictor data samples 122 and the response data samples 126 to learn relationships between predictor variables 124 and one or more response variables 128.

The model-development engine 116 can generate or update the timing-prediction model code 130. The timing-prediction model code 130 can include program code that is executable by one or more processing devices. The program code can include a set of modeling algorithms. A particular modeling algorithm can include one or more functions for accessing or transforming input wavelet predictor variable data, such as a set of shift values for a particular individual or other entity for each scale of a set of scales, one or more functions for computing scale-specific probabilities of a target event, such as an adverse action or other event of interest, and one or more functions for computing a combined probability of the target event from the computed scale-specific probabilities. Functions for computing the probability of target events can include, for example, applying a trained machine-learning model or other suitable model to the wavelet attributes. The trained machine-learning model can be a binary prediction model. In certain examples, the functions for computing the probability of the target event include applying the trained machine-learning model to each set of shift values of the set of wavelet attributes to determine a respective scale-specific probability and determining the probability of the target event as a function (e.g. an average) of the determined scale-specific probabilities. The trained model in these examples can be a tree-based model. In other examples, the functions for computing the probability of the target event include preprocessing the set of wavelet attributes to determine, from the sets of shift values of the wavelet attributes, a single set of values and applying the trained machine-learning model to the single set of values to determine the probability of the target event. The program code includes one or more functions for identifying, for each entity, a respective set of rows corresponding to separate shifts in the panel and concatenating the identified set of rows into a single row. The trained model in these other examples can be a logistic regression model or a neural network model. The program code for computing the probability of the target event can include model structures (e.g., layers in a neural network) and model parameter values (e.g., weights applied to nodes of a neural network, etc.).

The development computing system 114 may transmit, or otherwise provide access to, timing-prediction model code 130 that has been generated or updated with the model-development engine 116. For example, the host computing system 102 can receive the timing prediction model code 130 from the development computing system 114 and store the timing prediction model code 130 in a data storage unit 103 accessible to the host computing system 102. The host computing system 102 can execute the timing-prediction model code 130 and thereby compute an estimated time of a target event. The timing-prediction model code 130 can also include program code for computing a timing, within a target window, of an adverse action or other event based on the probabilities from various modeling algorithms that have been trained using the model-development engine 116 and historical predictor data samples 122 and response data samples 126 used as training data.

For instance, computing the timing of an adverse action or other events can include identifying which of the modeling algorithms were used to compute the highest probability for the adverse action or other event. Computing the timing can also include identifying a time bin associated with one of the modeling algorithms that was used to compute the highest probability value (e.g., the first three months, the first six months, etc.). The associated time bin can be the time period used to train the model implemented by the modeling algorithm. The associated time bin can be used to identify a predicted time period, in a subsequent target window for a given entity, in which the adverse action or other events will occur. For instance, if a modeling algorithm has been trained using data in the first three months of a training window, the predicted time period can be between zero and three months of a target window (e.g., defaulting on a loan within the first three months of the loan).

The operating environment 100 may also include one or more network-attached storage devices 118. The network-attached storage devices 118 can include memory devices for storing an entity data repository 120 and timing-prediction model code 130 to be processed by the development computing system 114. In some aspects, the network-attached storage devices 118 can also store any intermediate or final data generated by one or more components of the operating environment 100. In certain embodiments, the host computing system 102 includes a data storage unit 103 accessible to the host computing system 102 and the data storage unit 103 can include a memory device for storing timing-prediction model code 130 received from the development computing system 114.

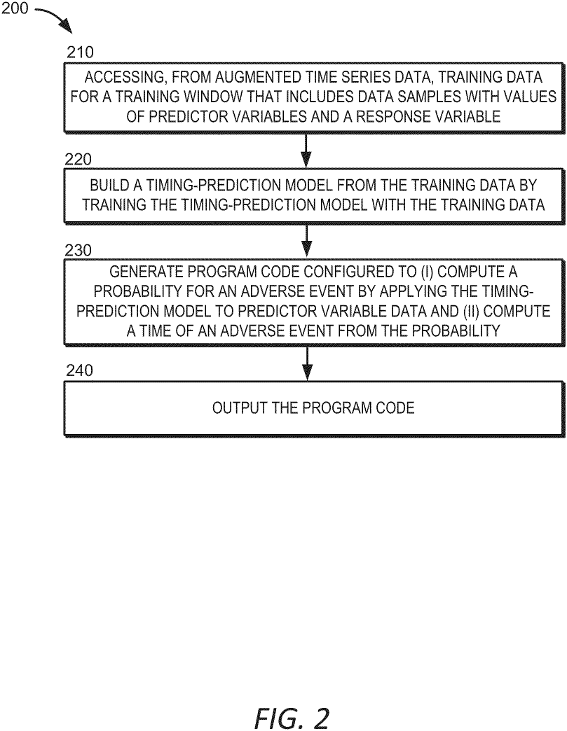

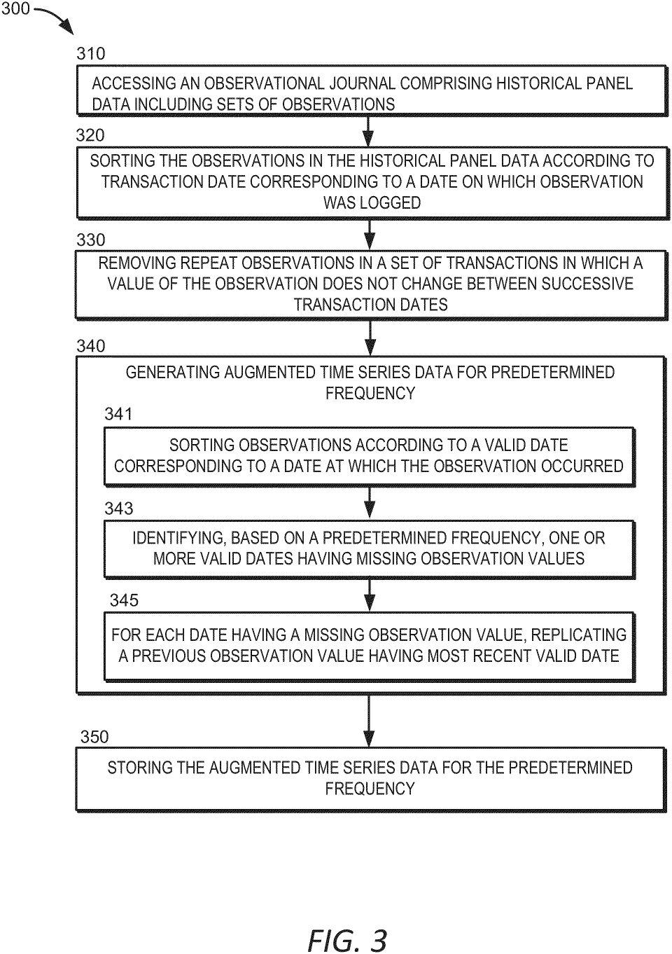

The entity data repository 120 can store historical panel data 121-1, observational journal data 121-2, augmented time series data 121-3, and training data 121-4 including predictor data samples 122 and response data samples 126. The external-facing subsystem 110 can prevent one or more host computing systems 102 from accessing the entity data repository 120 via a public data network 108. The historical panel data 121-1 can be provided by one or more host computing systems 102 or user computing systems 106, generated by one or more host computing systems 102 or user computing systems 106, or otherwise communicated within a operating environment 100 via a public data network 108. In certain embodiments, the model development engine 116 generates the observational journal data 121-2 from the historical panel data 121-1 and augmented time series data 121-3 from the observational journal data 121-2, for example, as described in FIG. 3 herein. The predictor data samples 122 and response data samples 126 can be obtained from the augmented time series data 121-3, for example, as described in FIG. 2 herein.

For example, historical panel data 121-1 including a large number of observations can be generated by electronic transactions, where a given observation includes one or more predictor variables (or data from which a predictor variable can be computed or otherwise derived). A given observation can also include data for a response variable or data from which a response variable value can be derived. Examples of predictor variables can include data associated with an entity, where the data describes behavioral or physical traits of the entity, observations with respect to the entity, prior actions or transactions involving the entity (e.g., information that can be obtained from credit files or records, financial records, user records, or other data about the activities or characteristics of the entity), or any other traits that may be used to predict the response associated with the entity. In some aspects, samples of predictor variables, response variables, or both can be obtained from credit files, financial records, user records, etc. In certain examples, the model development engine 116 can generate the augmented time series data 121-3 by increasing a frequency of a time series that can be constructed solely from the historical panel data 121-1. For example, the historical panel data 121-1 may include predictor and/or response variables at a monthly or biweekly time interval (or irregular time intervals) and the augmented time series data 121-3 that is generated from the historical panel data 121-1 may include predictor and/or response variables at a daily time interval. An example of a process to generate the augmented time series data 121-3 from historical panel data 121-1 is described in FIG. 3.

Network-attached storage devices 118 may also store a variety of different types of data organized in a variety of different ways and from a variety of different sources. For example, network-attached storage devices 118 may include storage other than primary storage located within development computing system 114 that is directly accessible by processors located therein. Network-attached storage devices 118 may include secondary, tertiary, or auxiliary storage, such as large hard drives, servers, virtual memory, among other types. Storage devices may include portable or non-portable storage devices, optical storage devices, and various other mediums capable of storing or containing data. A machine-readable storage medium or computer-readable storage medium may include a non-transitory medium in which data can be stored and that does not include carrier waves or transitory electronic signals. Examples of a non-transitory medium may include, for example, a magnetic disk or tape, optical storage media such as compact disk or digital versatile disk, flash memory, memory or memory devices.

In some aspects, the host computing system 102 can host an interactive computing environment. The interactive computing environment can receive a set of raw tradeline data. The interactive computing environment can determine time series data (e.g. panel data) from raw tradeline data, determine a wavelet transform that describes the time series data, and generate a set of wavelet predictor variable data using the time series data and the wavelet transform. The set of wavelet predictor variable data is used as input to the timing-prediction model code 130. The host computing system 102 can execute the timing-prediction model code 130 using the set of wavelet predictor variable data. The host computing system 102 can output an estimated time of an adverse action (or other events of interest) that is generated by executing the timing-prediction model code 130.

In additional or alternative aspects, a host computing system 102 can be part of a private data network 112. In these examples, the host computing system 102 can communicate with a third-party computing system that is external to the private data network 112 and that hosts an interactive computing environment. The third-party system can receive, via the interactive computing environment, a set of time series data for an entity. The third-party system can provide the set of time series data to the host computing system 102. The host computing system 102 can determine a wavelet transform that represents the time series data, and generate a set of wavelet predictor variable data using the wavelet transform and the time series data. In other examples, the third-party system can generate the set of wavelet predictor variable data and the host computing system 102 can receive the set of wavelet predictor variable data from the third-party system. The host computing system 102 can execute the timing-prediction model code 130 using the set of wavelet predictor variable data. The host computing system 102 can transmit, to the third-party system, an estimated time of an adverse action (or other events of interest) that is generated by executing the timing-prediction model code 130.

The output of the timing prediction model can be utilized to modify a data structure in the memory or a data storage device. For example, the predicted time of adverse event and/or the explanation codes can be utilized to reorganize, flag, or otherwise change the predictor variables involved in the prediction by the timing prediction model 130. For instance, predictor variables 124 (e.g., generated from augmented time series data) can be attached with flags indicating their respective amount of impact on the risk indicator. Different flags can be utilized for different predictor variables 124 to indicate different levels of impacts. Additionally, or alternatively, the locations of the predictor variables 124 in the storage, such as the entity data repository 120, can be changed so that the predictor variables 124 or groups of predictor variables 124 are ordered, ascendingly or descendingly, according to their respective amounts of impact on the risk indicator.

By modifying the predictor variables 124 in this way, a more coherent data structure can be established which enables the data to be searched more easily. In addition, further analysis of the the timing prediction model 130 and the outputs of the timing prediction model 130 can be performed more efficiently. For instance, predictor variables 124 having the most impact on the adverse event timing can be retrieved and identified more quickly based on the flags and/or their locations in the entity data repository 120. Further, updating the timing prediction model 130 such as re-training the timing prediction model 130 based on new values of the predictor variables 124, can be performed more efficiently especially when computing resources are limited. For example, updating or retraining the timing prediction model 130 can be performed by incorporating new values of the predictor variables 124 having the most impact on the output risk indicator based on the attached flags without utilizing new values of all the predictor variables 124.

A user computing system 106 can include any computing device or other communication device operated by a user, such as a user or a customer. The user computing system 106 can include one or more computing devices, such as laptops, smart phones, and other personal computing devices. A user computing system 106 can include executable instructions stored in one or more non-transitory computer-readable media. The user computing system 106 can also include one or more processing devices that are capable of executing program code to perform operations described herein. In various examples, the user computing system 106 can allow a user to access certain online services from a client computing system 101, to engage in mobile commerce with a client computing system 101, to obtain controlled access to electronic content hosted by the client computing system 101, etc. Communications within the operating environment 100 may occur over one or more public data networks 108. In one example, communications between two or more systems or devices can be achieved by a secure communications protocol, such as secure sockets layer (“SSL”) or transport layer security (“TLS”). In addition, data or transactional details may be encrypted. A public data network 108 may include one or more of a variety of different types of networks, including a wireless network, a wired network, or a combination of a wired and wireless network. Examples of suitable networks include the Internet, a personal area network, a local area network (“LAN”), a wide area network (“WAN”), or a wireless local area network (“WLAN”). A wireless network may include a wireless interface or combination of wireless interfaces. A wired network may include a wired interface. The wired or wireless networks may be implemented using routers, access points, bridges, gateways, or the like, to connect devices in a data network.

The operating environment 100 can secure communications among different devices, such as host computing systems 102, user computing systems 106, development computing systems 114, host computing systems 102, or some combination thereof. For example, the client systems may interact, via one or more public data networks 108, with various one or more external-facing subsystems 110. Each external-facing subsystem 110 includes one or more computing devices that provide a physical or logical subnetwork (sometimes referred to as a “demilitarized zone” or a “perimeter network”) that expose certain online functions of the operating environment 100 to an untrusted network, such as the Internet or another public data network 108.

Furthermore, the host computing system 102 can communicate with various other computing systems, such as client computing systems 101. For example, client computing systems 101 may send adverse event timing queries to the host computing system 102 for adverse event timing assessment, or may send signals to the host computing system 102 that control or otherwise influence different aspects of the host computing system 102. The client computing systems 101 may also interact with user computing systems 106 via one or more public data networks 108 to facilitate interactions between users of the user computing systems 106 and interactive computing environments provided by the client computing systems 101.

Each client computing system 101 may include one or more third-party devices, such as individual servers or groups of servers operating in a distributed manner. A client computing system 101 can include any computing device or group of computing devices operated by a seller, lender, or other providers of products or services. The client computing system 101 can include one or more server devices. The one or more server devices can include or can otherwise access one or more non-transitory computer-readable media. The client computing system 101 can also execute instructions that provide an interactive computing environment accessible to user computing systems 106. Examples of the interactive computing environment include a mobile application specific to a particular client computing system 101, a web-based application accessible via a mobile device, etc. The executable instructions are stored in one or more non-transitory computer-readable media.

The client computing system 101 can further include one or more processing devices that are capable of providing the interactive computing environment to perform operations described herein. The interactive computing environment can include executable instructions stored in one or more non-transitory computer-readable media. The instructions providing the interactive computing environment can configure one or more processing devices to perform operations described herein. In some aspects, the executable instructions for the interactive computing environment can include instructions that provide one or more graphical interfaces. The graphical interfaces are used by a user computing system 106 to access various functions of the interactive computing environment. For instance, the interactive computing environment may transmit data to and receive data from a user computing system 106 to shift between different states of the interactive computing environment, where the different states allow one or more electronics transactions between the user computing system 106 and the client computing system 101 to be performed.

In some examples, a client computing system 101 may have other computing resources associated therewith (not shown in FIG. 1), such as server computers hosting and managing virtual machine instances for providing cloud computing services, server computers hosting and managing online storage resources for users, server computers for providing database services, and others. The interaction between the user computing system 106 and the client computing system 101 may be performed through graphical user interfaces presented by the client computing system 101 to the user computing system 106, or through an application programming interface (API) calls or web service calls.

A user computing system 106 can include any computing device or other communication device operated by a user, such as a consumer or a customer. The user computing system 106 can include one or more computing devices, such as laptops, smartphones, and other personal computing devices. A user computing system 106 can include executable instructions stored in one or more non-transitory computer-readable media. The user computing system 106 can also include one or more processing devices that are capable of executing program code to perform operations described herein. In various examples, the user computing system 106 can allow a user to access certain online services from a client computing system 101 or other computing resources, to engage in mobile commerce with a client computing system 101, to obtain controlled access to electronic content hosted by the client computing system 101, etc.

For instance, the user can use the user computing system 106 to engage in an electronic transaction with a client computing system 101 via an interactive computing environment. An electronic transaction between the user computing system 106 and the client computing system 101 can include, for example, the user computing system 106 being used to request online storage resources managed by the client computing system 101, acquire cloud computing resources (e.g., virtual machine instances), and so on. An electronic transaction between the user computing system 106 and the client computing system 101 can also include, for example, query a set of sensitive or other controlled data, access online financial services provided via the interactive computing environment, submit an online credit card application or other digital application to the client computing system 101 via the interactive computing environment, operating an electronic tool within an interactive computing environment hosted by the client computing system (e.g., a content-modification feature, an application-processing feature, etc.).

In some aspects, an interactive computing environment implemented through a client computing system 101 can be used to provide access to various online functions. As a simplified example, a website or other interactive computing environment provided by an online resource provider can include electronic functions for requesting computing resources, online storage resources, network resources, database resources, or other types of resources. In another example, a website or other interactive computing environment provided by a financial institution can include electronic functions for obtaining one or more financial services, such as loan application and management tools, credit card application and transaction management workflows, electronic fund transfers, etc. A user computing system 106 can be used to request access to the interactive computing environment provided by the client computing system 101, which can selectively grant or deny access to various electronic functions. Based on the request, the client computing system 101 can collect data associated with the user and communicate with the host computing system 102 for adverse event timing assessment. Based on the adverse event timing predicted by the host computing system 102, the client computing system 101 can determine whether to grant the access request of the user computing system 106 to certain features of the interactive computing environment.

The adverse event timing (or predicted risk indicator) can be utilized by the service provider to determine the risk associated with the entity accessing a service provided by the service provider, thereby granting or denying access by the entity to an interactive computing environment implementing the service. For example, if the service provider determines that the adverse event timing (or predicted risk indicator) is later than a threshold adverse event timing (or lower than a threshold risk indicator value), then the client computing system 101 associated with the service provider can generate or otherwise provide access permission to the user computing system 106 that requested the access. The access permission can include, for example, cryptographic keys used to generate valid access credentials or decryption keys used to decrypt access credentials. The client computing system 101 associated with the service provider can also allocate resources to the user and provide a dedicated web address for the allocated resources to the user computing system 106, for example, by adding it in the access permission. With the obtained access credentials and/or the dedicated web address, the user computing system 106 can establish a secure network connection to the computing environment hosted by the client computing system 101 and access the resources via invoking API calls, web service calls, HTTP requests, or other proper mechanisms.

Each external-facing subsystem 110 can include, for example, a firewall device that is communicatively coupled to one or more computing devices forming a private data network 112. A firewall device of an external-facing subsystem 110 can create a secured part of the operating environment 100 that includes various devices in communication via a private data network 112. In some aspects, as in the example depicted in FIG. 1, the private data network 112 can include a development computing system 114, which executes a model-development engine 116, and one or more network-attached storage devices 118, which can store an entity data repository 120. In additional or alternative aspects, the private data network 112 can include one or more host computing systems 102 that execute a predictive response application 104.

In some aspects, by using the private data network 112, the development computing system 114 and the entity data repository 120 are housed in a secure part of the operating environment 100. This secured part of the operating environment 100 can be an isolated network (i.e., the private data network 112) that has no direct accessibility via the Internet or another public data network 108. Various devices may also interact with one another via one or more public data networks 108 to facilitate electronic transactions between users of the user computing systems 106 and online services provided by one or more host computing systems 102.

In some aspects, including the development computing system 114 and the entity data repository 120 in a secured part of the operating environment 100 can provide improvements over conventional architectures for developing program code that controls or otherwise impacts host system operations. For instance, the entity data repository 120 may include sensitive data aggregated from multiple, independently operating contributor computing systems (e.g., failure reports gathered across independently operating manufacturers in an industry, personal identification data obtained by or from credit reporting agencies, etc.). Generating timing-prediction model code 130 that more effectively impacts host system operations (e.g., by accurately computing timing of a target event) can require access to this aggregated data. However, it may be undesirable for different, independently operating host computing systems to access data from the entity data repository 120 (e.g., due to privacy concerns). By building timing-prediction model code 130 in a secured part of a operating environment 100 and then outputting that timing-prediction model code 130 to a particular host computing system 102 via the external-facing subsystem 110, the particular host system 102 can realize the benefit of using higher quality timing-prediction models (i.e., model built using training data from across the entity data repository 120) without the security of the entity data repository 120 being compromised.

Host computing systems 102 can be configured to provide information in a predetermined manner. For example, host computing systems 102 may access data to transmit in response to a communication. Different host computing systems 102 may be separately housed from each other device within the operating environment 100, such as development computing system 114, or may be part of a device or system. Host computing systems 102 may host a variety of different types of data processing as part of the operating environment 100. Host computing systems 102 may receive a variety of different data from the computing devices 102a-c, from the development computing system 114, from a cloud network, or from other sources.

### Examples of Generating a Timing-prediction Model

In one example, the model-development engine 116 can access training data that includes the predictor data samples 122 and response data samples 126. In some embodiments, the training data 121-4 is obtained from augmented time series data 123-3 that is generated from historical panel data 121-1 received via the observational journal 121-2. In some instances, historical panel data 121-1 received by the observational journal 121-2 is supplemented with subsequent panel data 121-5 received via the observational journal 121-2 after the historical panel data 121-1 was received. In some embodiments, the predictor data samples 122 and response data samples 126 include, for example, entity data for multiple entities, such as entities or other individuals within a training window. Response data samples 126 for a particular entity indicate whether or not an event of interest, such as an adverse action, has occurred within a given time period. Examples of a time window include 60 months, 36 months, or any other suitable time period. An example of an event of interest is a default, such as being ninety or more (90+) days past due on a specific account. In some embodiments, the training data is obtained from augmented time series data 121-3 that is generated from historical panel data 121-1. In certain embodiments, the predictor data samples 122 and response data samples include entity data for multiple entities over different time bins within a training window. Examples of a time bin include a month, a quarter of a performance window, a biannual period, or any other suitable time period within the time window.

In certain embodiments, the response data samples 126 for an entity indicate the occurrence of the event of interest in a particular time bin (e.g., a month), the model-development engine 116 can count the number of time bins (e.g., months) until the first time the event occurs in the training window. The model-development engine 116 can assign, to this entity, a variable t equal to the number of time bins (months). The performance window can have a defined starting time such as, for example, a date an account was opened, a date that the entity defaults on a separate account, etc. The performance window can have a defined ending time, such as 24 months after the defined starting time. If the response data samples 126 for an entity indicate the non-occurrence of the event of interest in the training window, the model-development engine 116 can set t to any time value that occurs beyond the end of the training window.

The model-development engine 116 can select predictor variables 124 in any suitable manner, including selecting predictor variables 124 from the augmented time series data 121-3 generated from the historical panel data 121-1. In some aspects, the model-development engine 116 can add, to the entity data repository 120, predictor data samples 122 with values of one or more predictor variables 124. One or more predictor variables 124 can correspond to one or more attributes measured in an observation window, which is a time period preceding the training window. For instance, predictor data samples 122 can include values indicating actions performed by an entity or observations of the entity. The observation window can include data from any suitable time period. In one example, an observation window has a length of one month. In another example, an observation window has a length of multiple months.

In some aspects, training a timing-prediction model used by a host computing system 102 can involve ensuring that the timing-prediction model provides a predicted response, as well as an explanatory capability. Certain predictive response applications require using models having an explanatory capability. An explanatory capability can involve generating explanatory data such as adverse action codes (or other reason codes) associated with independent variables that are included in the model. This explanatory data can indicate an effect, an amount of impact, or other contribution of a given independent variable with respect to a predicted response generated using an automated modeling algorithm. The model-development engine 116 can use one or more approaches for training or updating a given modeling algorithm. Examples of these approaches can include overlapping survival models, non-overlapping hazard models, and interval probability models.

### Examples of Operations Involving Machine Learning

FIG. 1A is a flow chart depicting an example of a process 150 for utilizing a timing prediction model 130 to predict a time of adverse event based on predictor variables. One or more computing devices (e.g., the host computing system 102) implement operations depicted in FIG. 1A by executing suitable program code (e.g., the timing prediction model code 130). For illustrative purposes, the process 150 is described with reference to certain examples depicted in the figures. Other implementations, however, are possible.

At block 152, the process 150 involves receiving an adverse event timing query for a target entity from a remote computing device, such as a computing device associated with the target entity requesting the adverse event timing. The adverse event timing query can also be received by the host computing system 102 from a remote computing device associated with an entity authorized to request adverse event timings of the target entity.

At block 154, the process 150 involves accessing a timing prediction model 130 trained to generate adverse event timings based on input predictor variables or other data suitable for assessing timings of adverse events associated with an entity. Examples of predictor variables can include data associated with an entity that describes prior actions or transactions involving the entity (e.g., information that can be obtained from credit files or records, financial records, consumer records, or other data about the activities or characteristics of the entity), behavioral traits of the entity, demographic traits of the entity, or any other traits that may be used to predict risks associated with the entity. In some aspects, predictor variables can be obtained from credit files, financial records, consumer records, etc. The adverse event timing can indicate a predicted time of occurrence of an adverse event (e.g., default on an account) associated with the entity (e.g., an account).

The timing prediction model 130 can be constructed and trained based on training samples including training predictor variables extracted from time series data. Additional details regarding training the timing prediction model 130 using augmented time series data is described in more detail in FIG. 2.

At block 156, the process 150 involves applying the timing prediction model 130 on input predictor variables to compute a time of adverse event. Predictor variables associated with the target entity, determined from time series data (e.g., the augmented time series data generated via the method described in FIG. 3), can be used as inputs to the timing prediction model 130. The predictor variables associated with the target entity can be obtained from augmented time series data stored in the data storage unit 103. The output of the timing prediction model 130 would include a timing of an adverse event for the target entity.

At block 158, the process 150 involves generating and transmitting a response to the adverse event query that includes the timing of the adverse event. The timing of the adverse event can be used for one or more operations that involve performing an operation with respect to the target entity based on the timing of the adverse event associated with the target entity. In one example, the timing of the adverse event can be utilized to control access to one or more interactive computing environments by the target entity. As discussed above with regard to FIG. 1, the host computing system 102 can communicate with client computing systems 101, which may send adverse event timing queries to the host computing system 102 to request timings of adverse events. The client computing systems 101 may be associated with technological providers, such as cloud computing providers, online storage providers, or financial institutions such as banks, credit unions, credit-card companies, insurance companies, or other types of organizations. The client computing systems 101 may be implemented to provide interactive computing environments for users to access various services offered by these service providers. Users can utilize user computing systems 106 to access the interactive computing environments thereby accessing the services provided by these providers.

For example, a user can submit a request to access the interactive computing environment using a user computing system 106. Based on the request, the client computing system 101 can generate and submit a risk assessment query for the customer to the host computing system 102. The adverse event timing query can include, for example, an identity of the customer and other information associated with the customer that can be utilized to generate predictor variables. The host computing system 102 can perform an adverse event timing assessment based on predictor variables generated for the customer and return the adverse event timing to the client computing system 101.

Based on the received adverse event timing, the client computing system 101 can determine whether to grant the customer access to the interactive computing environment. If the client computing system 101 determines that the level of risk associated with the customer accessing the interactive computing environment and the associated technical or financial service is too high, the client computing system 101 can deny access by the customer to the interactive computing environment. Conversely, if the client computing system 101 determines that the level of risk associated with the customer is acceptable, the client computing system 101 can grant access to the interactive computing environment by the customer and the customer would be able to utilize the various services provided by the service providers. For example, with the granted access, the customer can utilize the user computing system 106 to access clouding computing resources, online storage resources, web pages or other user interfaces provided by the client computing system 101 adverse event timing to execute applications, store data, query data, submit an online digital application, operate electronic tools, or perform various other operations within the interactive computing environment hosted by the client computing system 101.

FIG. 2 depicts an example of a process 200 for training a modeling algorithm and thereby estimating a time period in which a target event will occur. For illustrative purposes, the process 200 is described with reference to implementations described with respect to various examples depicted in FIG. 1. Other implementations, however, are possible. The operations in FIG. 2 are implemented in program code that is executed by one or more computing devices, such as the development computing system 114, the host computing system 102, or some combination thereof. In some aspects of the present disclosure, one or more operations shown in FIG. 2 may be omitted or performed in a different order. Similarly, additional operations not shown in FIG. 2 may be performed.

At block 210, the process 200 can involve accessing, from augmented time series data 121-3, training data 121-4 for a training window that includes data samples with values of predictor variables and a response variable. Each predictor variable can correspond to an action performed by an entity or an observation of the entity. The response variable can have a set of outcome values associated with the entity. The model-development engine 116 can implement block 210 by, for example, retrieving predictor data samples 122 and response data samples 126 from augmented time series data 121-3 stored on one or more non-transitory computer-readable media. In other aspects, the predictor variables and response variables include wavelet predictor variable data determined as described herein. FIG. 3 depicts an example of a process for generating, from historical panel data 121-1, augmented time series data 121-3, from which training data can be accessed for training the timing-prediction model of FIG. 1 using the process described in FIG. 2, according to certain embodiments disclosed herein. In certain embodiments, the observational journal data 121-1, into which the historical panel data 121-1 is received, can also receive subsequent panel data 121-5 received by the model development engine 116. For example, the model development engine 116 may periodically (e.g. monthly, biweekly, or at another predefined interval) receive subsequent panel data 121-5 via an observational journal 121-2 and augment, in the observational journal 121-1, the historical panel data 121-1 with the newly received subsequent panel data 121-5. In this example, the training data 121-4 includes predictor data samples 122 and response data samples 126 retrieved from augmented time series data 121-3 generated based on the observational journal data 121-2.

In some embodiments, the model-development engine 116 can partition the training data 121-4 into training data subsets for respective time bins within the training window. For example, the model-development engine 116 can create a first training subset having predictor data samples 122 and response data samples 126 with time indices in a first time bin, a second training subset having predictor data samples 122 and response data samples 126 with time indices in a second time bin, etc. In some aspects, the model-development engine 116 can identify a resolution of the training data 121-4 and partition the training data 121-4 based on the resolution. In one example, the model-development engine 116 can identify the resolution based on one or more user inputs, which are received from a computing device and specify the resolution (e.g., months, days, etc.). In another example, the model-development engine 116 can identify the resolution based on analyzing time stamps or other indices within the response data samples 126. The analysis can indicate the lowest-granularity time bin among the response data samples 126. For instance, the model-development engine 116 could determine that some data samples have time stamps identifying a particular month, without distinguishing between days, and other data samples have time stamps identifying a particular day from each month. In this example, the model-development engine 116 can use a “month” resolution for the portioning operation, with the data samples having a “day” resolution being grouped based on their month.

At block 220, the process 200 can involve building a timing-prediction model from the training data by training the timing-prediction model with the training data 121-4. In some aspects, the model-development engine 116 can implement block 220 by training the timing prediction model (e.g., a neural network, logistic regression, tree-based model, or other suitable model) to predict the likelihood of an event (or the event’s absence) during a particular time bin or other time period for the timing-prediction model. In certain embodiments, the process 220 can involve building a set of timing-prediction models from partitioned training data by training each timing-prediction model with the training data 121-4. For instance, a first timing-prediction model can learn, based on the training data 121-4, to predict the likelihood of an event occurring (or the event’s absence) during a three-month period, and a second timing-prediction model can learn, based on the training data 121-4, to predict the likelihood of the event occurring (or the event’s absence) during a six-month period.

In additional or alternative aspects, the model-development engine 116 can implement block 220 by selecting a relevant training data 121-4 subset and executing a training process based on the selected training data 121-4 subset. For instance, if a hazard function approach is used, the model-development engine 116 can train a timing prediction model 130 (e.g., a neural network, logistic regression, tree-based model, or other suitable model) for a first time bin (e.g., 0-3 months) using a subset of the predictor data samples 122 and response data samples 126 having time indices within the first time bin. The model-development engine 116 trains the model to, for example, compute a probability of a response variable value (taken from response data samples 126) based on different sets of values of the predictor variable (taken from the predictor data samples 122).

In some aspects, block 220 can involve computing survival functions for overlapping time bins. In additional or alternative aspects, block 220 involves computing hazard functions for non-overlapping time bins.

The model-development engine 116 can iterate block 220 for multiple time periods. Iterating block 220 can create a set of timing-prediction models that span entire training windows. In some aspects, each iteration uses the same set of training data (e.g., using an entire training dataset over a two-year period to predict an event’s occurrence or non-occurrence within three months, within six months, within twelve months, and so on). In additional or alternative aspects, such as hazard function approaches, this iteration is performed for each training data 121-4 subset.

At block 230, the process 200 can involve generating program code configured to (i) compute a set of probabilities for an adverse event by applying the set of timing-prediction models to predictor variable data and (ii) compute a time of the adverse event from the set of probabilities. For example, the model-development engine 116 can update the timing-prediction model code 130 to include various model parameters computed at block 220, to implement various model architectures computed at block 220, or some combination thereof.

In some aspects, computing a time of the adverse event (or other event of interest) at block 230 can involve computing a measure of central tendency with respect to a curve defined by the collection of different timing-prediction models across the set of time bins. For instance, the set of timing-prediction models can be used to compute a set of probabilities of an event’s occurrence or non-occurrence over time (e.g., over different time bins). The set of probabilities over time defines a curve. For instance, the collective set of timing-prediction models results in a survival function, a hazard function, or an interval probability function. A measure of central tendency for this curve can be used to identify an estimate of a particular predicted time period for the event of interest (e.g., a single point estimate of expected time-to-default). Examples of measures of central tendency include the mean time-to-event (e.g., area under the survival curve), a median time-to-event corresponding to the time where the survival function equals 0.5, and a mode of the probability function of the curve (e.g., the time at which the maximum value of probability function ƒ occurs). A particular measure of central tendency can be selected based on the characteristics of the data being analyzed. At block 230, a time at which the measure of central tendency occurs can be used as the predicted time of the adverse event or other event of interest. In various aspects, such measures of central tendency can also be used in timing-prediction models involving a survival function, in timing-prediction models involving a hazard function, in timing-prediction models involving an interval probability function, etc.

In aspects involving a timing-prediction model using a survival function, which indicates an event’s non-occurrence, the probability of the event’s occurrence for a particular time period can be derived from the probability of non-occurrence (e.g. by subtracting the probability of non-occurrence from 1), where the measure of central tendency is used as the probability of non-occurrence. In aspects involving a timing-prediction model using a hazard function, which indicates an event’s occurrence, the probability of the event’s occurrence for a particular time period can be the measure of central tendency is used as the probability of non-occurrence.

At block 240, the process 200 can involve outputting the program code. For example, the model-development engine 116 can output the program code to a host computing system 102. Outputting the program code can include, for example, storing the program code in a non-transitory computer-readable medium accessible by the host computing system 102, transmitting the program code to the host computing system 102 via one or more data networks, or some combination thereof.

### Embodiments for Generating Augmented Time Series Data From Which to Access Training Data

In some embodiments, training data 121-4 is obtained from augmented time series data 121-3 that is generated from historical panel data 121-1 in an observational journal 121-2 is, in some instances, augmented with subsequent panel data 121-5 received via the observational journal 121-2. FIG. 3 depicts an example of a process 300 for generating, from historical panel data 121-1, augmented time series data 121-3 from which training data 121-4 can be accessed for training a timing-prediction model using the process described in FIG. 2, according to certain embodiments disclosed herein.. For illustrative purposes, the process 300 is described with reference to implementations described with respect to various examples depicted in FIG. 1. Other implementations, however, are possible. The operations in FIG. 3 are implemented in program code that is executed by one or more computing devices, such as the development computing system 114, the host computing system 102, or some combination thereof. In some aspects of the present disclosure, one or more operations shown in FIG. 3 may be omitted or performed in a different order. Similarly, additional operations not shown in FIG. 3 may be performed. The example process 300 described in FIG. 3 to generate augmented time series data 121-3 may be used in process 200 described in FIG. 2. For example, at block 210 of FIG. 2, the model development engine 116 can access, from augmented time series data 121-3, training data 121-4 for a training window that includes data samples with values of predictor variables and a response variable.

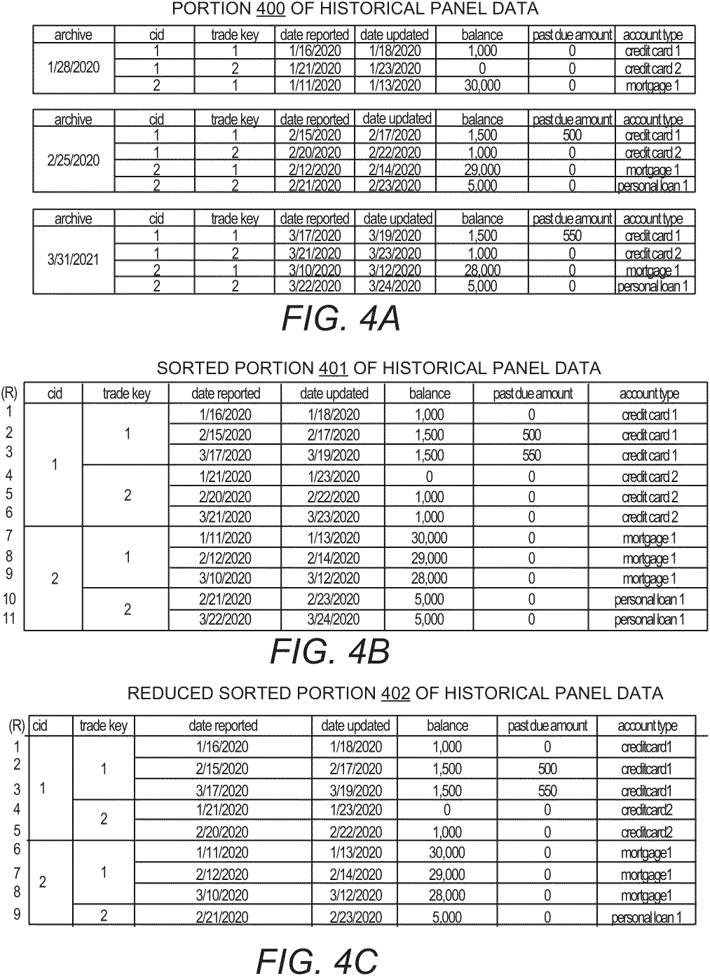

At block 310, the process 300 can involve accessing an observational journal 121-2 comprising historical panel data 121-1, the historical panel data 121-1 including sets of observations. For example, model-development engine 116 can access, in the observational journal 121-2, historical panel data 121-1 for one or more entities. For example, historical panel data 121-1, which includes a large number of observations, can be generated by electronic transactions, where a given observation includes one or more predictor variables (or data from which a predictor variable can be computed or otherwise derived). A given observation can also include data for a response variable or data from which a response variable value can be derived. Examples of predictor variables can include data associated with an entity, where the data describes behavioral or physical traits of the entity, observations with respect to the entity, prior actions or transactions involving the entity (e.g., information that can be obtained from credit files or records, financial records, user records, or other data about the activities or characteristics of the entity), or any other traits that may be used to predict the response associated with the entity. In some aspects, samples of predictor variables, response variables, or both can be obtained from credit files, financial records, user records, etc. In certain examples, the historical panel data 121-1 may include predictor and/or response variables at a monthly time interval. In certain embodiments, the model development engine 116 receives the historical panel data 121-1 from one or more data furnishers and saves the historical panel data 121-1, for example, in the observational journal 121-2 in the entity data repository 120. In certain example embodiments, the model development engine 116 associates portions of the historical panel data 121-1 with records (e.g. credit files) of individual entities (e.g. users). In certain examples, subsequent panel data 121-5 can be received at regular intervals (e.g. a monthly snapshot is received on a last day of a month) and the model development engine 116 can append the existing historical panel data 121-1 in the observational journal 121-2 with the new subsequent panel data 121-5. In certain examples, historical panel data 121-1 (and any subsequent panel data 121-5) can include, for each observation of a set of observations, a transaction date corresponding to when the model development engine 116 receives the observation or a date at which the data furnisher which generates the historical panel data 121-1 (and any subsequent panel data 121-5) updates a record (e.g. an account record) associated with the observation. In certain examples, the historical panel data 121-1 (and any subsequent panel data 121-5) can include, for each observation, a valid date corresponding to a date at which an update corresponding to the observation actually occurred. For example, an account could be updated on Feb. 20, 2021 and reflect a transaction resulting in a decrease in an account balance of $50 which actually occurred on Feb. 18, 2021. In this example, the transaction date is February 20 and the valid date is February 18. FIG. 4A depicts an illustration of example of a portion of historical panel data 121-1.

At block 320, the process 300 can involve sorting the observations in the historical panel data 121-1 according to a transaction date corresponding to a date on which the observation was logged. In certain embodiments, the model-development engine 116 can hierarchically sort observations in historical panel data 121-1 according to one or more categories (e.g., by CID or other entity identifier, by transaction type, by account number, etc.). The hierarchically sorted observations can be sorted according to transaction date. For example, the transaction date of each respective observation in the time series data corresponds to a date at which the credit data furnisher (or other system that furnishes historical panel data 121-1 to the model development engine 116) logs or otherwise updates account information associated with the observation. FIG. 4B depicts an example illustration of the portion of historical panel data 121-1 of FIG. 4A which is sorted according to transaction date, in accordance with certain embodiments described herein.

At block 330, the process 300 can involve removing repeat observations in a set of observations in which a value of the observation does not change between successive transaction dates. For example, the model-development engine 116 can remove repeat observations within the time series data. For example, a repeat observation may be two or more successive observations (according to transaction date) in which an observation value does not change in view of a previous observation. In this example, the model-development environment may remove, in the historical panel data 121-1 and for a set of observations including a previous observation and one or more repeat successive observations, all observations in the set except for the repeat observation with the earliest transaction date. FIG. 4C depicts an example illustration of the sorted portion of historical panel data of FIG. 4B in which duplicate observations are removed to generate a reduced sorted portion of historical panel data, in accordance with certain embodiments described herein.

At block 340, the process 300 can involve generating augmented time series data for a predetermined frequency. For example, the historical panel data 121-1 could include, for a month of March, 2020 for a particular account of a particular entity, observations corresponding to account balance values for transaction dates of March 2, March 5, March 13, and March 25. Accordingly, in this example, the historical panel data 121-1 includes account balance information for irregular intervals (3 days, 8 days, and 12 days) within the month of March, 2020. In this example, the model development engine 116 could generate, from this historical panel data 121-1 including observations for transaction dates of March 2, March 5, March 13, and March 25, augmented time series data 121-3 that includes account balance information for dates of March 1-31. Accordingly, by model development engine 116 can increase a granularity of a time series derivable from the historical panel data 121-1 by generating the augmented time series data 121-3 through augmenting the historical panel data 121-1.

In some embodiments, each observation in the historical panel data 121-1 (and each observation in any subsequent panel data 121-5) includes a user identifier (CID) identifying an entity (e.g., customer) associated with the observation, as well as an observation type (e.g., trade, collection, inquiry, etc.). For example, a record layout for a trade type observation is different from a record layout for a collection or inquiry record. In these embodiments, since the record layout is specific to a type of observation, separate augmented time series data 121-3 can be created for each observation type. For example, a first augmented time series can be created for trade observations, a second augmented time series can be created for collection observations, a third augmented time series can be created for inquiry observations, etc.

In certain embodiments, the process 300, at block 340, can involve performing sub-blocks 341, 343, and 345.

At sub-block 341, the process 300 can involve sorting observations according to a valid date corresponding to a date at which the observation occurred. For example, the valid date for each observation within the historical panel data 121-1 (and for each observation within any subsequent panel data 121-5) corresponds to a date at which the respective observation occurred (e.g. an actual transaction date). As previously discussed, the transaction date is the date at which a system which reports the observation (e.g. a creditor, a financial institution, etc.) to the model development engine 116 logs the observation. In some instances, the valid date does not correspond to the transaction date. In other instances, the valid date corresponds to the transaction date.

At sub-block 343, the process 300 involves identifying, based on the predetermined frequency, one or more valid dates having missing observation values. Continuing with a previous example, for historical panel data 121-1 including observations for transaction dates of March 2, March 5, March 13, and March 25, the respective valid dates and account balance data for each of these observations could be February 28 ($200), March 3 ($220), March 11 ($120), and March 25 ($800), respectively. Accordingly, in this example, for the month of March, the model development engine 116 could identify March 1-2, March 4-10, March 12-24, and March 26-31 as valid dates for which observation values are missing.

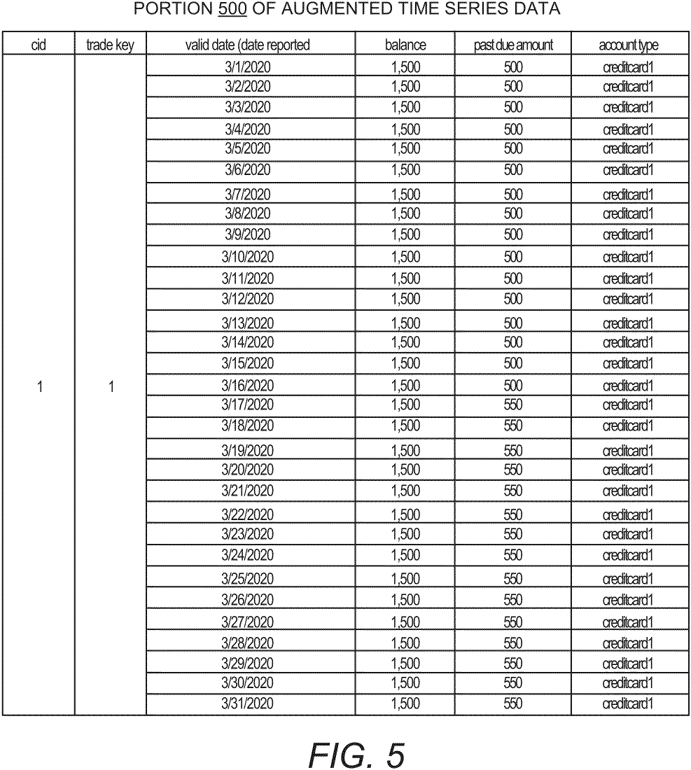

At sub-block 345, the process 300 involves replicating, for each date having a missing observation value, a previous observation value having a most recent valid date. For example, continuing with the previous example, for the historical panel data 121-1 including valid dates (and account balances) of February 28 ($200), March 3 ($220), March 11 ($120), and March 25 ($800), the model development engine 116 can replicate account balance values for the missing valid dates of March 1-2, March 4-10, March 12-24, and March 26-31. In this example, the model development engine 116 can replicate the account balance of $200 of valid date February 28 for each of missing valid dates of March 1-2, replicate the account balance of $220 for each of missing valid dates of March 4-10, replicate the account balance of $10 for each of missing valid dates of March 12-24, and replicate the account balance of $800 for each of missing valid dates of March 26-31. Accordingly, at sub-block 345, the model development engine 116 can replicate, for observations associated with a particular entity (CID) and account, observation values for missing valid dates to generate an augmented time series of a predetermined frequency. FIG. 5 depicts an example illustration of augmented time series data at a daily interval for a customer and trade key, in accordance with certain embodiments described herein.

In certain examples, the process 300 can repeat block 340 (and associated sub-blocks 341, 343, 345) for each observation type of the historical panel data 121-1 to generate separate augmented time series data 121-3 for each observation type. For example, observation types may include a trade, a collection, an inquiry, or other type associated with observations in the historical panel data 121-1. The model development engine 116 can generate each augmented time series data 121-3 by augmenting the historical panel data 121-1 for each observation type to generate augmented time series data 121-3 of a predefined frequency.

From block 340, the method 300 proceeds to block 350. At block 350, the process 300 can involve storing augmented time series data 121-3 for the predetermined frequency. For example, the model development engine 116 can combine (e.g. stack) and output the augmented time series data. The model development engine 116 can store the augmented time series data 121-3 for the predetermined frequency in the entity data repository 120. In certain examples, the model development engine 116 can access training data 121-4 from the augmented time series data 121-3, including predictor data samples 122 and response data samples 126, as described in block 210 of FIG. 2, and can train a timing prediction model using the extracted training data 121-4.

FIG. 4A depicts an example illustration of a portion 400 of historical panel data 121-1, which can be used in certain embodiments herein. For example, the process 300 can involve receiving, at block 310, historical panel data 121-1 in a format that is analogous to the example portion of historical panel data 121-1 illustrated in FIG. 4A. The portion of historical panel data 121-1 illustrated in FIG. 4A depicts 3 archives from January, February, and March 2020. As illustrated in FIG. 4A, the archives can include, respectively, multiple observations associated with each row and, for each observation, information associated with the observation. Particularly, in the example of FIG. 4A, the information associated with each observation includes a user identifier (“CID”) identifying an entity, a trade account number (“trade key”), an account type, a reported balance (“balance”), a past due amount, a transaction date (“date updated”), and a valid date (“date reported”). In the example of FIG. 4A, the balance amount tracks the account balance for each month associated with a particular trade key for a particular CID. For example, as shown in FIG. 4A, the balance of trade key 1 associated with CID 1 is 1,000 on transaction date Jan. 18, 2020 received in the January archive (received Jan. 28, 2020), is 1,500 on transaction date Feb. 17, 2020 received in the February archive (received Feb. 25, 2020), and is 1,500 on transaction date Mar. 19, 2020 received in the March archive (received Mar. 31, 2020). Continuing with this example, the past due amount of trade key 1 associated with CID 1 is 0 on transaction date Jan. 18, 2020 received in the January archive (received Jan. 28, 2020), is 500 on transaction date Feb. 17, 2020 received in the February archive (received Feb. 25, 2020), and is 550 on transaction date Mar. 19, 2020 received in the March archive (received Mar. 31, 2020). In this example, the valid dates associated with these transaction dates are Jan. 16, 2020, Feb. 15, 2020, and Mar. 17, 2020, respectively. Accordingly, it can be inferred in this example that, on valid date (date reported) of Feb. 15, 2020, the balance increased by 500 to 1500 and the past due amount increased from the previous valid date of Jan. 16, 2020 by 500 from 0 to 500 and that these balance and past due amount increases were logged by the credit data furnisher on Feb. 17, 2020. Further, it can be inferred in this example that, on valid date (date reported) of Mar. 17, 2020, the balance remained the same as the previous balance of valid date Feb. 15, 2020 and the past due amount increased from the previous valid date of Feb. 15, 2020 by 50 from 500 to 550 and that this balance report and past due amount increase which actually occurred on Mar. 17, 2020 were logged by the credit data furnisher on Mar. 19, 2020 and included in the archive data of Mar. 31, 2021 received by the model development engine 116 from the time series data furnisher.

FIG. 4B depicts an example illustration of the portion of historical panel data 121-1 of FIG. 4A which is sorted, in accordance with certain embodiments described herein. As depicted in FIG. 4B, the sorted portion 401 of historical panel data 121-1 of FIG. 4A is hierarchically sorted according to CID (user identifier) and trade key (trade account number), and transaction date (date updated). The hierarchical sorting depicted in FIG. 4B is an example, and other hierarchical sorting methods may be used, for example, sorting first by trade key and then by CID, or other hierarchical sorting method to generate an alternative sorted portion 401 than depicted in FIG. 4B. As depicted in FIG. 4B, the observations (the rows) are sorted according to a transaction date (“date updated”). For example, for CID 1, trade key 1, the observations are depicted in the order of transaction dates (dates updated) of Jan. 18, 2020, Feb. 17, 2020, and Mar. 19, 2020.

FIG. 4C depicts an example illustration of the sorted portion of historical panel data of FIG. 4B in which duplicate observations are removed to generate a reduced sorted portion of historical panel data, in accordance with certain embodiments described herein. In the sorted portion 401 of time series data of FIG. 4B, which includes 11 observations, observations represented by rows (R) 5 and 6 are a set of repeat observations and observations represented by rows 10 and 11 are another set of repeat observations. For example, the observation of row 6 is a repeat observation of the observation of row 5 because values of the balance (1000) and pastdueamount (0) for creditcard2 of customer CID 1 remains unchanged between the transaction dates Feb. 22, 2020 and Mar. 23, 2020 of these two observations. Likewise, the observation of row 11 is a repeat observation of the observation of row 10 because values of the balance (5000) and pastdueamount (0) for personal loan 1 of customer CID 2 remains unchanged between the transaction dates of Feb. 23, 2020 and Mar. 24, 2020 of these two observations. Accordingly, the later observation of each of these sets of repeat observations, when considered according to transaction date (date updated), can be removed to generate the reduced sorted portion 402 of time series data as depicted in FIG. 4C, which has 9 observations. Note that the following observations, in generating the reduced sorted portion 402 of the time series data in FIG. 4C, have been removed from FIG. 4B: {cid 1, trade key 2, date reported Mar. 21, 2020, date updated Mar. 23, 2020, balance 1000, pastdueamount 0, accounttype credit card 2} and {cid 2, trade key 2, date reported Mar. 22, 2020, date updated Mar. 24, 2020, balance 5000, pastdueamount 0, accounttype personal loan 1}.

FIGS. 4B and 4C depict an example in which duplicate transaction(s) having later transaction dates are removed and an earliest of a set of duplicate transactions is retained. However, in some embodiments, determining which duplicate transaction(s) to remove is dependent on the predetermined frequency of the augmented time series data 121-3. For example, when constructing a time series at a monthly predefined frequency, the model development engine 116 can include one (1) observation per account within each monthly period. In this example, if the model development engine 116 encounters, within a particular month, a set of successive duplicate observations in the historical panel data 121-1, the model development engine 116 retains a latest observation by transaction date and removes observations of the set of successive duplicate observations having a transaction date earlier than the latest observation. However, in these embodiments, when constructing an augmented time series at a predefined frequency (e.g. daily) and a set of duplicate observations including observations that occur at a frequency that is greater than the predetermined frequency (e.g. multiple transactions within a day where the predefined frequency is daily), the model development engine 116 can remove the earlier of the set of duplicate observations and retail only the latest of the set of duplicate observations. For example, in an augmented time series including a daily predefined frequency, duplicate observations may only be removed if more than one of a set of duplicate observations correspond to a single transaction date in the historical panel data 121-1. For example, for the historical panel data 121-1 includes a first observation having a transaction date of April 01 at 9.00 am and a balance is $100 and a second observation having the same transaction date of April 01 but at 6.00 pm and the balance is $500. In this case the latest balance at 6.00 pm will be retained and the earlier balance at 9.00am will be removed.

FIG. 5 depicts an example illustration of a portion 500 of time series data generated based on the reduced sorted portion of historical panel data of FIG. 4C, from which training data can be extracted for the process of FIG. 2, in accordance with certain embodiments described herein. The portion 500 of time series data depicted in FIG. 5 corresponds to customer CID 1 and trade key 1 for a range of valid dates between March 1 to Mar. 31, 2020. However, the time series data can further include data for CID 1 trade key 2, CID 2 trade key 1, and CID trade key 2 of FIG. 4C, as well as for a range of valid dates greater than or less than the example range illustrated in FIG. 5. As depicted in FIG. 5, the model development engine 116 can preserve, for valid date of March 17 (shown in bold), the account balance of $1500 and past due amount of $550 corresponding to the observation 2 in FIG. 4C on valid date Mar. 17, 2020. As depicted in FIG. 5, the model development engine 116 can replicate, for valid dates of March 1-16, the account balance of $1500 and the past due amount of $500 corresponding to the previous valid date of Feb. 15, 2020 corresponding to observation 2 of FIG. 4C. As depicted in FIG. 5, the model development engine 116 can replicate, for valid dates of March 18-31, the account balance of $1500 and the past due amount of $550 corresponding to the previous valid date of Mar. 17, 2020 corresponding to observation 3 of FIG. 4C.

### Examples for Generating, Editing, or Updating Augmented Time Series Data Based On Panel Data Received Via the Observational Journal Subsequently to Archived Panel Data

In certain embodiments, the augmented time series data 121-3, which is generated from the observational journal data 121-2, can be augmented with subsequent panel data 121-5 that is received by the model development engine 116 via the observational journal data 121-2. For example, the model development engine 116 may periodically (e.g. monthly, biweekly, or at another predefined interval) receive subsequent panel data 121-5 , incorporate the new observations in the subsequent panel data 121-5 into the observational journal 121-2, and can generate augmented time series data 121-3 based on both the historical panel data 121-1 and the newly received subsequent panel data 121-5. In certain embodiments, the model development engine 116 determines one or more observation types associated with observations within the subsequent panel data 121-5 archive and, for observations within the newly received subsequent panel data 121-5 for each observation type, retrieves the augmented time series data 121-3 portion relevant to the observation type and adds a new section to the augmented time series data 121-3 according to the predefined frequency of the augmented time series data 121-3. For example, the augmented time series data 121-3 has a daily frequency and the model development engine creates 31 new rows for each of the dates of a new time period (e.g. a subsequent month that includes 31 days) corresponding to the new subsequent panel data 121-5 archive received via the observational journal 121-2. Continuing with this example, the model development engine can determine a valid date for each of the set of observations of the respective observation type and populate a respective row (e.g. daily time points) in the new section of the augmented time series data 121-3 associated with each valid date in the set of observations with a respective predictor variable value from the subsequent panel data 121-5 archive received via the observational journal 121-2. Continuing with this example, the model development engine can, for each missing value representing a missing observation in the subsequent panel data 121-5, replicate a value associated with a most recent valid date. The model development engine 116 can thus generate , edit, and/or update augmented time series data 121-3 each time subsequent panel data 121-5 is received via the observational journal 121-2.

For example, the historical panel data 121-1 includes monthly observational archives from August 2016 to June 2021 and the model development engine 116 can generate augmented time series data 121-3 from this historical panel data 121-1 according to the example method described in FIG. 3 in June of 2021. Continuing with this example, the model development engine 116 may receive, in August of 2021 via the observational journal 121-2, a subsequent panel data 121-5 archive including a new set of observations for July of 2021. The model development engine 116 may determine one or more observation types of observations within the subsequent panel data 121-5 archive and, for each observation type, retrieve the augmented time series data 121-3 relevant to the observation type and add a new section to the time series data according to the predefined frequency of the augmented time series data 121-3. For example, the augmented time series data 121-3 has a daily frequency and the model development engine creates 31 new rows for each of the dates of the month of July 2021 (which includes 31 days) corresponding to the subsequent panel data 121-5 archive.

Continuing with this example, the model development engine can determine a valid date for each of the set of observations of the respective observation type and populate a respective row (e.g., daily time points) in the new section of the augmented time series data 121-3 associated with each valid date in the set of observations with a respective predictor variable value from the subsequent panel data 121-5 archive. The model development engine can, for each missing value representing a missing observation in the new section of the augmented time series data 121-3, replicate a value associated with a most recent valid date. For example, the subsequent panel data 121-5 archive may include account balances for credit card account 1 of entity 1 for valid dates of July 2 ($400), July 19 ($800), and July 26 ($600). In this example, the subsequent panel data 121-5 received via the observational journal 121-2 is missing observational values for dates of July 1, July 3-18, July 20-25, and July 27-31. In this example, the model development engine 116 may, in the new section of the augmented time series data 121-3, replicate a value from the previous month of May 2021 for the July 1 date, replicate the $400 value associated with valid date July 2 for each of the dates of July 3-18, replicate the $800 value associated with valid date July 19 for each of the dates of July 20-25, and replicate the value of $600 for each of the dates of July 27-31.

In certain embodiments, the training data 121-4 includes predictor data samples 122 and response data samples 126 retrieved from the augmented time series data 121-3.

### Examples of Host System Operations Using a Set of Timing-Prediction Models

A host computing system 102 can execute the timing-prediction model code 130 to perform one or more operations. In an illustrative example of a process executed by a host computing system 102, the host computing system 102 can receive or otherwise access predictor variable data. For instance, a host computing system 102 can be communicatively coupled to one or more non-transitory computer-readable media, either locally or via a data network. The host computing system 102 can request, retrieve, or otherwise access time series data (or other types of data depending on the type of prediction model) with respect to a target, such as a target individual or other entity. In certain embodiments, the host computing system 102 can access time series data generated based on historical panel data 121-1 using an observational journal 121-2, as described in certain embodiments herein. In certain embodiments, the host computing system 102 can access augmented time series data 121-3 generated based on historical panel data 121-1 and which, in some instances, is later augmented based on subsequent panel data 121-5 received, via an observational journal 121-2, successive to the historical panel data 121-1.

In certain embodiments, the host computing system 102 can compute a set of probabilities (or other types of risk indicator) for the target event by executing the predictive response application 104, which can include program code outputted by a development computing system 114. Executing the program code can cause one or more processing devices of the host computing system 102 to apply the timing-prediction model, which has been trained with the development computing system 114, to the predictor variable data.

The host computing system 102 can modify a host system operation based on the computed time of the target event. For instance, the time of a target event can be used to modify the operation of different types of machine-implemented systems within a given operating environment.

In some aspects, a target event includes or otherwise indicates a risk of failure of a hardware component within a set of machinery or a malfunction associated with the hardware component. A host computing system 102 can compute an estimated time until the failure or malfunction occurs. The host computing system 102 can output a recommendation to a user computing system 106, such as a laptop or mobile device used to monitor a manufacturing or medical system, a diagnostic computing device included in an industrial setting, etc. The recommendation can include the estimated time until the malfunction or failure of the hardware component, a recommendation to replace the hardware component, or some combination thereof. The operating environment can be modified by performing maintenance, repairs, or replacement with respect to the affected hardware component.

In additional or alternative aspects, a target event indicates a risk level associated with a target entity that is described by or otherwise associated with the predictor variable data. Modifying the host system operation based on the computed time of the target can include causing the host computing system 102 or another computing system to control access to one or more interactive computing environments by a target entity associated with the predictor variable data.

For example, the host computing system 102, or another computing system that is communicatively coupled to the host computing system 102, can include one or more processing devices that execute instructions providing an interactive computing environment accessible to user computing systems 106. Examples of the interactive computing environment include a mobile application specific to a particular host computing system 102, a web-based application accessible via mobile device, etc. In some aspects, the executable instructions for the interactive computing environment can include instructions that provide one or more graphical interfaces. The graphical interfaces are used by a user computing system 106 to access various functions of the interactive computing environment. For instance, the interactive computing environment may transmit data to and receive data from a user computing system 106 to shift between different states of interactive computing environment, where the different states allow one or more electronics transactions between the user computing system 106 and the host computing system 102 (or other computing system) to be performed. If a risk level is sufficiently low (e.g., is less than a user-specified threshold), the host computing system 102 (or other computing system) can provide a user computing system 106 associated with the target entity with access to a permitted function of the interactive computing environment. If a risk level is too high (e.g., exceeds a user-specified threshold), the host computing system 102 (or other computing system) can prevent a user computing system 106 associated with the target entity from accessing a restricted function of the interactive computing environment.

### Examples of Timing-Prediction Models

In some aspects, the timing-prediction model can be a neural network model. A neural network can be trained in any suitable manner. For instance, the connections between nodes can have numeric weights that can be tuned based on experience. Such tuning can make neural networks adaptive and capable of “learning.” Additionally, or alternatively, a neural network model can be trained by iteratively adjusting the predictor variables represented by the neural network, the number of nodes in the neural network, or the number of hidden layers in the neural network. Adjusting the predictor variables can include eliminating the predictor variable from the neural network. Adjusting the number of nodes in the neural network can include adding or removing a node from a hidden layer in the neural network. Adjusting the number of hidden layers in the neural network can include adding or removing a hidden layer in the neural network.

In certain examples, the timing-prediction model can be a logistic regression model. A logistic regression model can be generated by determining an appropriate set of logistic regression coefficients that are applied to predictor variables in the model. For example, input attributes in a set of training data are used as the predictor variables. The logistic regression coefficients are used to transform or otherwise map these input attributes into particular outputs in the training data (e.g., predictor data samples 122 and response data samples 126).

In certain embodiments, the timing-prediction model can be a model that is applied to wavelet predictor variable data. For example, the host computing system 102 generates wavelet predictor variable data by determining a wavelet transform to represent the time series data and generate a set of wavelet predictor variable data using the wavelet transform and the time series data. The wavelet predictor variable data includes a set of shift values for each of a set of scales. The wavelet predictor variable data can be represented by a matrix having rows representing scales and columns representing shifts, where each row of values in the matrix represents a set of shift values corresponding to a particular scale. The host computing system 102 can apply the timing prediction model to each set of shift values (corresponding to each scale) to determine a set of scale-specific probabilities corresponding to the number of scales in the wavelet predictor variable data. The host computing system 102 determines a combined probability as a function of the set of scale-specific probabilities. For instance, an average, a weighted average, a median, or other function is applied to a particular set of scale-specific probabilities for the timing prediction model to determine the combined probability. The host computing system 102 can also compute, from the combined probability, a time of a target event (e.g., an adverse action or other events of interest).

In certain examples, the timing-prediction model can be a tree-based machine-learning model. For example, the model-development engine 116 can retrieve an objective function and partition, for each predictor variable in the set X, a corresponding set of the predictor data samples 122 (i.e., predictor variable values) and determine the various partitions that maximize the objective function. The model-development engine 116 can select a partition that results in an overall maximized value of the objective function as compared to each other partition in the set of partitions. The model-development engine 116 can perform a split that results in two child node regions, such as a left-hand region R_{L} and a right-hand region R_{R}. The model-development engine 116 can determine if a tree-completion criterion has been encountered. Examples of tree-completion criterion include, but are not limited to: the tree is built to a prespecified number of terminal nodes, or a relative change in the objective function has been achieved. The model-development engine 116 can output the decision tree.

### Examples for Modifying an Interactive Computing Environment

The following discussion involves, for illustrative purposes, a simplified example of an interactive computing environment implemented through a host computing system 102 to provide access to various online functions. In this example, a user of a user computing system 106 can engage in an electronic transaction with a host computing system 102 via an interactive computing environment. An electronic transaction between the user computing system 106 and the host computing system 102 can include, for example, the user computing system 106 being used to query a set of sensitive or other controlled data, access online financial services provided via the interactive computing environment, submit an online credit card application or other digital application to the host computing system 102 via the interactive computing environment, operating an electronic tool within an interactive computing environment provided by a host computing system 102 (e.g., a content-modification feature, an application-processing feature, etc.), or perform some other electronic operation within a computing environment.

For instance, a website or other interactive computing environment provided by a financial institution’s host computing system 102 can include electronic functions for obtaining one or more financial services, such as loan application and management tools, credit card application and transaction management workflows, electronic fund transfers, etc. A user computing system 106 can be used to request access to the interactive computing environment provided by the host computing system 102, which can selectively grant or deny access to various electronic functions.

Based on the request, the host computing system 102 can collect data associated with the customer and execute a predictive response application 104, which can include a set of timing-prediction model code 130 that is generated with the development computing system 114. Executing the predictive response application 104 can cause the host computing system 102 to compute a risk indicator (e.g., a risk assessment score, a predicted time of occurrence for the target event, etc.). The host computing system 102 can use the risk indicator to instruct another device, such as a web server within the same computing environment as the host computing system 102 or an independent, third-party computing system in communication with the host computing system 102. The instructions can indicate whether to grant the access request of the user computing system 106 to certain features of the interactive computing environment.

For instance, if timing data (or a risk indicator derived from the timing data) indicates that a target entity is associated with a sufficient likelihood of a particular risk, a user computing system 106 used by the target entity can be prevented from accessing certain features of an interactive computing environment. The system controlling the interactive computing environment (e.g., a host computing system 102, a web server, or some combination thereof) can prevent, based on the threshold level of risk, the user computing system 106 from advancing a transaction within the interactive computing environment. Preventing the user computing system 106 from advancing the transaction can include, for example, sending a control signal to a web server hosting an online platform, where the control signal instructs the web server to deny access to one or more functions of the interactive computing environment (e.g., functions available to authorized users of the platform).

Additionally or alternatively, modifying the host system operation based on the computed time of the target can include causing a system that controls an interactive computing environment (e.g., a host computing system 102, a web server, or some combination thereof) to modify the functionality of an online interface provided to a user computing system 106 associated with the target entity. For instance, the host computing system 102 can use timing data (e.g., an adverse action timing prediction) generated by the timing-prediction model code 130 to implement a modification to an interface of an interactive computing environment presented at a user computing system 106. In this example, the user computing system 106 is associated with a particular entity whose predictor variable data is used to compute the timing data. If the timing data indicates that a target event for a target entity will occur in a given time period, the host computing system 102 (or a third-party system with which the host computing system 102 communicates) could rearrange the layout of an online interface so that features or content associated with a particular risk level are presented more prominently (e.g., by presenting online products or services targeted to the risk level), features or content associated with different risk levels are hidden, presented less prominently, or some combination thereof.

In various aspects, the host computing system 102 or a third-party system performs these modifications automatically based on an analysis of the timing data (alone or in combination with other data about the entity), manually based on user inputs that occur subsequent to computing the timing data with the timing-prediction model code 130, or some combination thereof. In some aspects, modifying one or more interface elements is performed in real time, i.e., during a session in which a user computing system 106 accesses or attempts to access an interactive computing environment. For instance, an online platform may include different modes, in which a first type of interactive user experience (e.g., placement of menu functions, hiding or displaying content, etc.) is presented to a first type of user group associated with a first risk level and a second type of interactive user experience is presented to a second type of user group associated with a different risk level. If, during a session, timing data is computed that indicates that a user of the user computing system 106 belongs to the second group, the online platform could switch to the second mode.

In some aspects, modifying the online interface or other features of an interactive computing environment can be used to control communications between a user computing system 106 and a system hosting an online environment (e.g., a host computing system 102 that executes a predictive response applications 104, a third-party computing system in communication with the host computing system 102, etc.). For instance, timing data generated using a timing prediction model could indicate that a user computing system 106 or a user thereof is associated with a certain risk level. The system hosting an online environment can require, based on the determined risk level, that certain types of interactions with an online interface be performed by the user computing system 106 as a condition for the user computing system 106 to be provided with access to certain features of an interactive computing environment. In one example, the online interface can be modified to prompt for certain types of authentication data (e.g., a password, a biometric, etc.) to be inputted at the user computing system 106 before allowing the user computing system 106 to access certain tools within the interactive computing environment. In another example, the online interface can be modified to prompt for certain types of transaction data (e.g., payment information and a specific payment amount authorized by a user, acceptance of certain conditions displayed via the interface) to be inputted at the user computing system 106 before allowing the user computing system 106 to access certain portions of the interactive computing environment, such as tools available to paying customers. In another example, the online interface can be modified to prompt for certain types of authentication data (e.g., a password, a biometric, etc.) to be inputted at the user computing system 106 before allowing the user computing system 106 to access certain secured datasets via the interactive computing environment.

In additional or alternative aspects, a host computing system 102 can use timing data generated by the timing-prediction model code 130 to generate one or more reports regarding an entity or a group of entities. In a simplified example, knowing when an entity, such as a borrower, is likely to experience a particular adverse action, such as a default, could allow a user of the host computing system 102 (e.g., a lender) to more accurately price certain online products, to predict time between defaults for a given customer and thereby manage customer portfolios, optimize and value portfolios of loans by providing timing information, etc.

### Examples of Example of Computing System

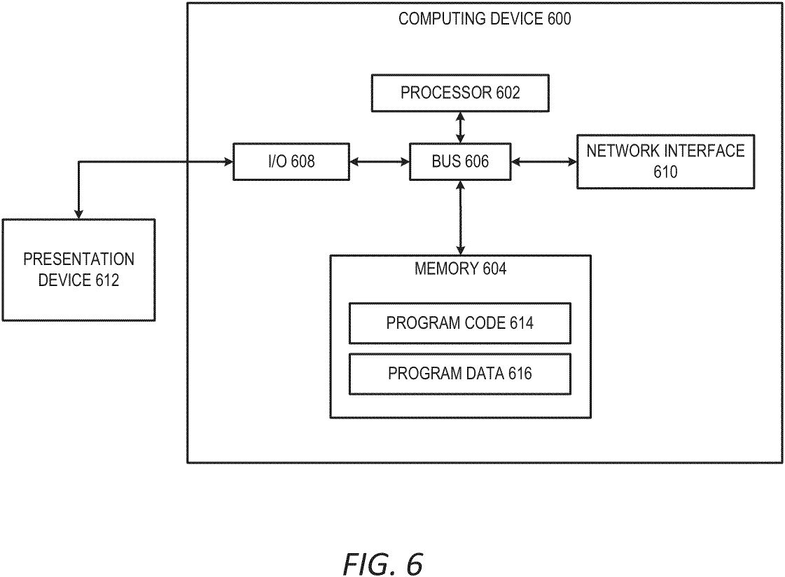

Any suitable computing system or group of computing systems can be used to perform the operations for the machine-learning operations described herein. For example, FIG. 6 is a block diagram depicting an example of a computing device 600, which can be used to implement the host computing system 102 (including the predictive response application 104) and the development computing system 114 (including the model development engine 116). The computing device 600 can include various devices for communicating with other devices in the operating environment 100, as described with respect to FIG. 1. The computing device 600 can include various devices for performing one or more operations described above with respect to FIGS. 1-5.

The computing device 600 can include a processor 602 that is communicatively coupled to a memory 604. The processor 602 executes computer-executable program code stored in the memory 604, accesses information stored in the memory 604, or both. Program code may include machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc. may be passed, forwarded, or transmitted via any suitable means including memory sharing, message passing, token passing, network transmission, among others.

Examples of a processor 602 include a microprocessor, an application-specific integrated circuit, a field-programmable gate array, or any other suitable processing device. The processor 602 can include any number of processing devices, including one. The processor 602 can include or communicate with a memory 604. The memory 604 stores program code that, when executed by the processor 602, causes the processor to perform the operations described in this disclosure.

The memory 604 can include any suitable non-transitory computer-readable medium. The computer-readable medium can include any electronic, optical, magnetic, or other storage device capable of providing a processor with computer-readable program code or other program code. Non-limiting examples of a computer-readable medium include a magnetic disk, memory chip, optical storage, flash memory, storage class memory, ROM, RAM, an ASIC, magnetic storage, or any other medium from which a computer processor can read and execute program code. The program code may include processor-specific program code generated by a compiler or an interpreter from code written in any suitable computer-programming language. Examples of suitable programming language include Hadoop, C, C++, C#, Visual Basic, Java, Python, Perl, JavaScript, ActionScript, etc.

The computing device 600 may also include a number of external or internal devices such as input or output devices. For example, the computing device 600 is shown with an input/output interface 608 that can receive input from input devices or provide output to output devices. A bus 606 can also be included in the computing device 600. The bus 606 can communicatively couple one or more components of the computing device 600.

The computing device 600 can execute program code 614 that includes the predictive response application 104 and the model development engine 116. The program code 614 for the predictive response application 104 and/or the model development engine 116 may be resident in any suitable computer-readable medium and may be executed on any suitable processing device. For example, as depicted in FIG. 6, the program code 614 for the predictive response application 104 and/or the model development engine 116 can reside in the memory 604 at the computing device 600 along with the program data 616 associated with the program code 614, such as the predictor variables 124 and/or the initial training data 121-4. Executing the predictive response application 104 and/or the model development engine 116 can configure the processor 602 to perform the operations described herein.

In some aspects, the computing device 600 can include one or more output devices. One example of an output device is the network interface device 610 depicted in FIG. 6. A network interface device 610 can include any device or group of devices suitable for establishing a wired or wireless data connection to one or more data networks described herein. Non-limiting examples of the network interface device 610 include an Ethernet network adapter, a modem, etc.

Another example of an output device is the presentation device 612 depicted in FIG. 6. A presentation device 612 can include any device or group of devices suitable for providing visual, auditory, or other suitable sensory output. Non-limiting examples of the presentation device 612 include a touchscreen, a monitor, a speaker, a separate mobile computing device, etc. In some aspects, the presentation device 612 can include a remote client-computing device that communicates with the computing device 600 using one or more data networks described herein. In other aspects, the presentation device 612 can be omitted.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

What is claimed is:

1. A method that includes one or more processing devices, comprising:
receiving, from a remote computing device, a query for a timing of an adverse event associated with a target entity;
determining, using a timing prediction model trained using a training process, the timing of the adverse event for the target entity from predictor variables associated with the target entity, wherein the training process includes operations comprising:
accessing an observational j ournal comprising historical panel data of the target entity including values of predictor variables for one or more time points;
generating, from the historical panel data, an augmented time series by augmenting the historical panel data with values of predictor variables for at time points for which the historical panel data does not include values of predictor variables, wherein augmenting the historical panel data comprises:
identifying a first time point in the historical panel data, the first time point associated with a first predictor variable value;
inserting, in the historical panel data at one or more subsequent time points following the first time point at a frequency, the first predictor variable value;
generating, using at least part of the augmented time series, training data; and
training the predictive model using the training data to predict timings of adverse events for target entities; and
transmitting, to the remote computing device, a responsive message including at least the timing of the adverse event for use in controlling access of the target entity to one or more interactive computing environments.

2. The method of claim 1, wherein the one or more time points of the historical panel data are at a first frequency, wherein the augmented time series comprises time points at a second frequency, and wherein the second frequency is greater than the first frequency.

3. The method of claim 1, wherein inserting the first predictor variable value at the one or more subsequent time points following the first time point at the frequency comprises:
identifying, in the historical panel data between the first time point and a second time point, one or more time points that do not include predictor variable values, wherein the second time point includes a second predictor variable value;
inserting, in the historical panel data, the first predictor variable value at each of the one or more time points that do not include predictor variable values.

4. The method of claim 1, wherein the time points correspond to dates on which observations occurred, the method further comprising sorting the historical panel data according to the dates.

5. The method of claim 4, further comprising:
identifying, in the sorted historical panel data, a predictor variable value that does not change between two successive time points; and
removing, in the historical panel data, a later of the two successive time points to generate a modified historical panel data, wherein the augmented time series is generated from the modified historical panel data.

6. The method of claim 1, wherein the observational journal comprisesat least one predictor variable value for at least one time point logged successively to the one or more time points in the historical panel data,
wherein generating the augmented time series further comprises incorporating the at least one predictor variable value for at least one time point logged successively to the one or more time points in the historical panel data.

7. The method of claim 1, wherein augmenting the historical panel data further comprises sorting the historical panel data, wherein sorting the historical panel data comprises sorting time points in the historical panel data according to a date of occurrence associated with each time point, wherein the identifying and inserting operations are performed on the sorted historical panel data.

8. A system, comprising:
a processing device; and
a memory device in which instructions executable by the processing device are stored for causing the processing device to perform operations comprising:
receiving, from a remote computing device, a query for a timing of an adverse event associated with a target entity;
determining, using a timing prediction model trained using a training process, the timing of the adverse event for the target entity from predictor variables associated with the target entity, wherein the training process includes operations comprising:
accessing an observational journal comprising historical panel data of the target entity including values of predictor variables for one or more time points;
generating, from the historical panel data, an augmented time series by augmenting the historical panel data with values of predictor variables for at time points for which the historical panel data does not include values of predictor variables, wherein augmenting the historical panel data comprises:
identifying a first time point in the historical panel data, the first time point associated with a first predictor variable value;
inserting, in the historical panel data at one or more subsequent time points following the first time point at a frequency, the first predictor variable value; and
generating, using at least part of the augmented time series, training data, wherein the training process includes training the predictive model using the training data to predict timings of adverse events for target entities; and
transmitting, to the remote computing device, a responsive message including at least the timing of the adverse event for use in controlling access of the target entity to one or more interactive computing environments.

9. The system of claim 8, wherein the one or more time points of the historical panel data are at a first frequency, wherein the augmented time series comprises time points at a second frequency, and wherein the second frequency is greater than the first frequency.

10. The system of claim 8, wherein inserting the first predictor variable value at the one or more subsequent time points following the first time point at the frequency comprises:
identifying, in the historical panel data between the first time point and a second time point, one or more time points that do not include predictor variable values, wherein the second time point includes a second predictor variable value;
inserting, in the historical panel data, the first predictor variable value at each of the one or more time points that do not include predictor variable values.

11. The system of claim 8, wherein the time points correspond to dates on which observations occurred and the method further comprising sorting the historical panel data according to the dates.

12. The system of claim 11, the operations further comprising:
identifying, in the sorted historical panel data, a predictor variable value that does not change between two successive time points; and
removing, in the historical panel data, a later of the two successive time points to generate a modified historical panel data, wherein the augmented time series is generated from the modified historical panel data.

13. The system of claim 8, wherein the observational journal comprises at least one predictor variable value for at least one time point logged successively to the one or more time points in the historical panel data,
wherein generating the augmented time series further comprises incorporating the at least one predictor variable value for at least one time point logged successively to the one or more time points in the historical panel data.

14. The system of claim 8, wherein augmenting the historical panel data further comprises sorting the historical panel data, wherein sorting the historical panel data comprises sorting time points in the historical panel data according to a date of occurrence associated with each time point, wherein the identifying and inserting operations are performed on the sorted historical panel data.

15. A non-transitory computer-readable medium, comprising computer-executable program instructions that, when executed by a processor, cause the processor to perform operations comprising:
receiving, from a remote computing device, a query for a timing of an adverse event associated with a target entity;
determining, using a timing prediction model trained using a training process, the timing of the adverse event for the target entity from predictor variables associated with the target entity, wherein the training process includes operations comprising:
accessing an observational journal comprising historical panel data of the target entity including values of predictor variables for one or more time points;
generating, from the historical panel data, an augmented time series by augmenting the historical panel data with values of predictor variables for at time points for which the historical panel data does not include values of predictor variables, wherein augmenting the historical panel data comprises:
identifying a first time point in the historical panel data, the first time point associated with a first predictor variable value;
inserting, in the historical panel data at one or more subsequent time points following the first time point at a frequency, the first predictor variable value; and
generating, using at least part of the augmented time series, training data, wherein the training process includes training the predictive model using the training data to predict timings of adverse events for target entities; and
transmitting, to the remote computing device, a responsive message including at least the timing of the adverse event for use in controlling access of the target entity to one or more interactive computing environments.

16. The non-transitory computer-readable medium of claim 15, wherein the one or more time points of the historical panel data are at a first frequency, wherein the augmented time series comprises time points at a second frequency, and wherein the second frequency is greater than the first frequency.

17. The non-transitory computer-readable medium of claim 15, wherein inserting the first predictor variable value at the one or more subsequent time points following the first time point at the frequency comprises:
identifying, in the historical panel data between the first time point and a second time point, one or more time points that do not include predictor variable values, wherein the second time point includes a second predictor variable value;
inserting, in the historical panel data, the first predictor variable value at each of the one or more time points that do not include predictor variable values.

18. The non-transitory computer-readable medium of claim 15, wherein the time points correspond to dates on which observations occurred and the method further comprising sorting the historical panel data according to the dates.

19. The non-transitory computer-readable medium of claim 18, the operations further comprising:
identifying, in the sorted historical panel data, a predictor variable value that does not change between two successive time points; and
removing, in the historical panel data, a later of the two successive time points to generate a modified historical panel data, wherein the augmented time series is generated from the modified historical panel data.

20. The non-transitory computer-readable medium of claim 15, wherein the observational journal including at least one predictor variable value for at least one time point logged successively to the one or more time points in the historical panel data,
wherein generating the augmented time series further comprises incorporating the at least one predictor variable value for at least one time point logged successively to the one or more time points in the historical panel data.
